(19) United States
(12) Patent Application Publication
(10) Pub. No.: US 2008/0287574 A1
(43) Pub. Date: Nov. 20, 2008

(54) ADHESIVES, SEALANTS AND COATINGS CONTAINING GLASS PARTICLES AS A FILLER

(76) Inventors: Helmut Loth, Haan (DE); Carsten Friese, Duesseldorf (DE); Johann Klein, Duesseldorf (DE); Oliver Schmidt, Langenfeld (DE)

Correspondence Address: HENKEL CORPORATION, 1001 TROUT BROOK CROSSING, ROCKY HILL, CT, 06067, US

(21) Appl. No.: 12/119,111

(22) Filed: May 12, 2008

(30) Foreign Application Priority Data
Nov. 10, 2005 (EP) PCT/EP2005/012073

(51) Int. Cl. C09J 11/04; C08K 3/40

(52) U.S. Cl. 524/35; 524/589; 524/590; 524/563; 524/556; 524/571; 524/570; 524/567; 524/588

(57) ABSTRACT

The invention relates to chemically or physically curable compositions suitable as adhesives or sealants or coating materials, which compositions contain at least one binding agent selected from the group comprising crosslinkable or polymerizable monomers, prepolymers, or polymers, as well as at least one filler. The filler proportion is 0.2 to 70 wt % based on the total weight of the compositions, and at least a portion of the filler is made up of glass particles having a particle size from 100 nm to 20 μm, which have been obtained by comminuting foamed neutral or acid glass.

### CROSS-REFERENCE TO RELATED APPLICATIONS

This application is a continuation under 35 USC Sections 365(c) and 120 of International Application No. PCT/EP2005/012073, filed 10 Nov. 2005 and published 18 May 2007 as WO 2007/054112, which is incorporated herein by reference in its entirety.

### FIELD OF THE INVENTION

The present invention relates to chemically or physically curable compositions suitable as adhesives or sealants or coating materials, which compositions contain at least one binding agent selected from the group comprising crosslinkable or polymerizable monomers, prepolymers, or polymers, as well as at least one filler.

### DISCUSSION OF THE RELATED ART

Adhesives, sealants, and coating materials generally contain fillers in addition to binding agents and, if applicable, pigments and solvents. These fillers are used for various purposes. The viscosity of the compositions, for example, can be adjusted by way of the nature and quantity of the fillers used. In many cases, flow behavior is also influenced by fillers, i.e. they act as rheology control agents. Once the adhesives, sealants, and coating materials have cured, the fillers also influence the physical and chemical properties of the cured end product. For example, the strength, elasticity, abrasion resistance, burning characteristics, and further properties of cured polymeric compounds are influenced by the nature and quantities of the fillers contained therein.

One important filler is finely particulate silicon dioxide. It is used, for example, in silicone rubber compositions or paints. Silicon dioxide has several disadvantages, however. On the one hand, this material is relatively expensive, and on the other hand in many compositions it can be used, for practical purposes, only up to a concentration of approximately 20 wt %. If greater quantities are used, the viscosity of the compositions rises so much that they are no longer processable.

### BRIEF SUMMARY OF THE INVENTION

It is the object of the present invention to describe adhesives, sealants, and coating materials of the kind cited above in which silicon dioxide is replaced at least partially by a different filler that is more economical and at the same time results in improved technical properties of the compositions. Surprisingly, it has now been found that this object can be achieved by the fact that at least a portion of the filler is made up of comminuted foamed glass that is contained in the compositions in a specific quantity and at a specific particle size.

The subject matter of the present invention is therefore adhesives or sealants or coating materials of the kind cited above which are characterized in that the filler proportion is 0.2 to 70 wt % based on the total weight of the compositions, and at least a portion of the filler is made up of glass particles having a particle size from 100 nm to 20 μm, which have been obtained by comminuting foamed neutral or acid glass or are made up of flat glass platelets that were manufactured from a glass melt under vacuum, the molten glass having been driven outward in a rotating crucible and having dissociated into the platelets upon cooling, or is made up of amorphous synthetic quartz glass (fused silica) or of flake-shaped glass particles that were obtained by pulling a glass capillary and comminuting the cooled capillary, or is made up of glass particles that were obtained by the fact that molten glass was processed into thin layers, hollow spheres, or tubules, and the layers, hollow spheres, or tubules were comminuted after cooling.

### DETAILED DESCRIPTION OF CERTAIN EMBODIMENTS OF THE INVENTION

The aforesaid flat glass platelets and their manufacture are described in WO 8808412 A1.

The glass particles made up of amorphous quartz glass are described in High Performance Fillers, 2005, 8-9 Mar. 2005, Cologne, Paper 19, on p. 3.

The glass particles manufactured from capillaries are offered, under the designation Glass Flake, by the Nippon Sheet Glass company.

The invention will be described below with reference to the comminuted glass foam. This description is to be understood in such a way that the comminuted glass foam can in all cases be replaced by the glass particles described above.

The filler is advantageously made up of the aforesaid glass particles at a proportion of 10 to 100 wt %, particularly preferably 50 to 100 wt %, very particularly preferably 100 wt %.

The term “neutral or acid glass” is to be understood as follows: When the glass particles are introduced into water and a dispersion having a 4-wt % concentration of glass particles is thus produced, a certain pH is established. If this pH is 7, the glass is then neutral. Glasses that yield a pH below 7 are acid glasses. A neutral pH can also be obtained by a mixture of acid and alkaline glass. Such a mixture is also to be understood as a neutral glass for purposes of the present invention.

Either recycled glass or new glass manufactured specifically for manufacture of the glass particles can be used for manufacture of the glass particles. In the latter case, it is possible specifically to control the properties of the glass particles by way of the composition of the glass. Additives that positively influence the properties of the glass particles as a filler can thus be added to the glass.

Glass particles that are obtainable by comminuting foamed glass, and the manufacture thereof, are described in German Patent DE 102 52 693 A1. These are platelet-shaped and/or three-dimensional, irregularly or regularly shaped glass particles. They are manufactured by adding at least one propellant to molten glass that is under pressure, then performing a pressure reduction, and then comminuting into glass particles the foam produced upon pressure reduction and pressure relief.

If the highly dispersed silicic acid usually used in the compositions according to the present invention is entirely replaced by the aforesaid glass particles, the glass powder can be used up to a content of approx. 70 wt %. It is to be regarded as surprising that the glass powder does not lead to destruction of the polymer matrix of the cured compositions, but instead that the physical and chemical properties therefore are improved in many ways.

In an advantageous embodiment of the present invention, the surface of the glass particles is chemically modified. This makes it possible advantageously to influence the interactions between the glass particles and the surrounding polymer matrix in the cured product. For example, the surface can be silanized. Further advantageous embodiments are evident from the dependent claims.

Advantageous compositions into which the aforementioned glass particles are incorporated according to the present invention are explained below in further detail.

The compositions can advantageously contain 2-cyanoacrylic acid esters as crosslinkable monomers. In this case, these are so-called cyanoacrylate adhesives. These are one-component reactive adhesives based on monomeric 2-cyanoacrylic acid esters. They have conquered the market as a result of their extremely fast curing, which (depending on the substrate) requires only a few seconds. The resulting properties meet many requirements that occur in industrial practice. The addition of glass particles corresponding to the present invention improves the toughening, peeling strength, heat resistance, tensile shear strength, and tensile strength of cyanoacrylate adhesives.

Suitable 2-cyanoacrylic acid esters in cyanoacrylate adhesives are substances of the general formula

H₂C═C(CN)—CO—O—R.

The cyanoacrylate adhesives can additionally contain 2-cyanopentadienoic acid esters as well as the addition of an effective quantity of at least one alkylene bis(2-pentadienoate). Cyanoacrylate adhesives of this kind are known from DE 196 40 202 A1. They exhibit elevated heat resistance.

A further advantageous embodiment of the present invention is provided by radiation-curable compositions containing cyanoacrylate. DE 198 80 965 T1, for example, describes compositions that encompass a cyanoacrylate component, a metallocene component, and a photoinitiator component.

The cyanoacrylate adhesives according to the present invention can further contain, in addition to a cyanoacrylate component, a first accelerator component that is selected from the group comprising calixarenes and oxacalixarenes, silicon-containing crown ethers, cyclodextrins, and combinations thereof; and a second accelerator component that is selected from the group comprising poly(ethylene glycol) di(meth)acrylates, ethoxylated compounds, and combinations thereof. These adhesives cure particularly quickly. They are described in U.S. Pat. No. 6,294,629 B1.

A further advantageous embodiment is constituted by one-component adhesive compositions that encompass a cyanoacrylate monomer, at least one plasticizing agent, and at least one silane, with the stipulation that the silicon atom of the silane does not form part of a silacrown ring. These adhesives are especially suitable for adhesive bonding of glass, and are described in European Patent EP 0 918 832 B1.

A further preferred embodiment of the cyanoacrylate adhesives according to the present invention is those that contain an ester additive, the ester used being at least one partial and/or full ester of mono- or polyvalent aliphatic carboxylic acids having 1 to 5 carbon atoms directly joined to one another and mono- to pentavalent aliphatic alcohol having 1 to 5 carbon atoms directly joined to one another, the number of carbon atoms directly joined to one another in the further aliphatic groups being a maximum of 3 when one aliphatic group contains 4 or 5 carbon atoms. These adhesives are characterized by a polymer content from 1 to 60 wt % based on the adhesive as a whole. They are described in German Patent Application DE 197 52 893 A1. They exhibit good shelf stability, usable strength values, and a practically unchanged setting speed.

A further example of an adhesive according to the present invention is a fluorescing cyanoacrylate adhesive that contains a pyrylium salt. Adhesives of this kind are suitable for adhesive bonding of similar or different materials made of metal, elastomers, and plastics, including especially for adhesive bonding of transparent fitting parts made of polystyrene, polymethyl methacrylate, and polycarbonate. They are described in German Patent Application DE 196 44 332 A1.

A further example of an adhesive according to the present invention is a cyanoacrylate adhesive having an ester additive, which is characterized in that the ester used is at least a partial or full ester of mono- or polyvalent aliphatic carboxylic acids having 1 to 5 carbon atoms directly joined to one another and mono- to pentavalent aliphatic alcohol having 1 to 5 carbon atoms directly joined to one another, the number of carbon atoms directly joined to one another in the further aliphatic groups being a maximum of 3 when one aliphatic group contains 4 or 5 carbon atoms, the ester additive being free of alkali metals and amines. These adhesives are described in European Patent EP 0 904 328 B1.

The cyanoacrylate adhesives according to the present invention can furthermore contain 2-oxo-1,3,2-dioxathiolanes, in quantities from 50 to 5000 ppm, as an inhibitor of anionic polymerization. This inhibitor causes the setting time to be drastically extended over the storage time. Adhesives of this kind are described in European Patent EP 1 034 223 B1.

A further suitable adhesive contains at least one cyanoacrylate monomer component that is selected from ethyl cyanoacrylate or methoxycyanoacrylate and at least one cyanoacrylate monomer component, in a quantity of more than 12 wt % based on the total weight of the combination, that is selected from the group comprising n-propyl cyanoacrylate, isopropyl cyanoacrylate, n-butyl cyanoacrylate, sec.-butyl cyanoacrylate, isobutyl cyanoacrylate, tert.-butyl cyanoacrylate, n-pentyl cyanoacrylate, 1-methyl butyl cyanoacrylate, 1-ethyl propyl cyanoacrylate, neopentyl cyanoacrylate, n-hexyl cyanoacrylate, 1-methyl pentyl cyanoacrylate, n-heptyl cyanoacrylate, n-octyl cyanoacrylate, n-nonyl cyanoacrylate, n-decyl cyanoacrylate, n-undecyl cyanoacrylate, n-dodecyl cyanoacrylate, cyclohexyl cyanoacrylate, benzyl cyanoacrylate, phenyl cyanoacrylate, tetrahydrofurfuryl cyanoacrylate, allyl cyanoacrylate, propargyl cyanoacrylate, 2-butenyl cyanoacrylate, phenethyl cyanoacrylate, chloropropyl cyanoacrylate, ethoxyethyl cyanoacrylate, ethoxypropyl cyanoacrylate, ethoxyisopropyl cyanoacrylate, propoxyethyl cyanoacrylate, isopropoxyethyl cyanoacrylate, butoxyethyl cyanoacrylate, methoxypropyl cyanoacrylate, methoxyisopropyl cyanoacrylate, methoxybutyl cyanoacrylate, propoxymethyl cyanoacrylate, propoxyethyl cyanoacrylate, propoxypropyl cyanoacrylate, butoxymethyl cyanoacrylate, butoxyethyl cyanoacrylate, butoxypropyl cyanoacrylate, butoxyisopropyl cyanoacrylate, butoxybutyl cyanoacrylate, isononyl cyanoacrylate, isodecyl cyanoacrylate, cyclohexyl methyl cyanoacrylate, naphtyl cyanoacrylate, 2-(2′-methoxy)ethoxyethyl cyanoacrylate, 2-(2′-ethoxy)ethoxyethyl cyanoacrylate, 2-(2′-propyloxy)ethoxyethyl cyanoacrylate, 2-(2′-butyloxy)ethoxyethyl cyanoacrylate, 2-(2′-pentyloxy)ethoxyethyl cyanoacrylate, 2-(2′-hexyloxy)ethoxyethyl cyanoacrylate, 2-(2′-methoxy)propyloxypropyl cyanoacrylate, 2-(2′-ethoxy)propyloxypropyl cyanoacrylate, 2-(2′-propyloxy)propyloxypropyl cyanoacrylate, 2-(2′-pentyloxy)propyloxypropyl cyanoacrylate, 2-(2′-hexyloxy)propyloxypropyl cyanoacrylate, 2-(2′-methoxy)butyloxybutyl cyanoacrylate, 2-(2′-ethoxy)butyloxybutyl cyanoacrylate, 2-(2′-butyloxy)butyloxybutyl cyanoacrylate, 2-(3′-methoxy)propyloxyethyl cyanoacrylate, 2-(3′-methoxy)butyloxyethyl cyanoacrylate, 2-(3′-methoxy)propyloxypropyl cyanoacrylate, 2-(3′-methoxy)butyloxypropyl cyanoacrylate, 2-(2′-methoxy)ethoxypropyl cyanoacrylate, 2-(2′-methoxy)ethoxybutyl cyanoacrylate. The composition additionally contains at least one plasticizer component that is contained in a quantity from approximately 15 to approximately 40 wt % based on the entire composition. These adhesives are described in Patent Application WO 02/053666 A1.

The adhesives can furthermore contain, in addition to a cyanoacrylate component, an accelerator that is characterized by the following chemical structure:

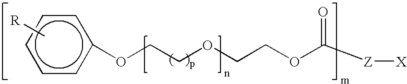

in which R is a radical that is selected from the group comprising hydrogen, alkyl, alkoxy, alkylthio ethers, haloalkyl, carboxyl acids and esters thereof sulfinic, sulfonic, and sulfuric acids and esters thereof phosphinic, phosphonic, and phosphoric acids and esters thereof, X is an aromatic hydrocarbon radical that can be substituted with oxygen or sulfur, Z is a single or double bond, n=1 to 12, m=1 to 4, and p=1 to 3. Cyanoacrylates of this kind are described in U.S. Pat. No. 6,835,789.

A further advantageous embodiment of the invention is provided by adhesive based on α-cyanoacrylic acid esters that contain a pyrylium salt. This makes it possible to add a dye at high concentration to the cyanoacrylic acid ester without thereby perceptibly degrading shelf stability and adhesion properties. It is possible to prepare stock solutions with which cyanoacrylate adhesives can easily be colored in accordance with a particular application. Adhesives of this kind are described in WO 98/18876.

The cyanoacrylate adhesives can furthermore contain 2-oxo-1,3,2-dioxathiolanes as an inhibitor of anionic polymerization, as described in WO 99/25774. Along with a reliable inhibiting action, this counteracts any lengthening of the setting time after storage.

Improved toughness in the cured cyanoacrylate adhesives is achieved by an elastomeric copolymer as toughness additive, which is a reaction product of a C₂₋₂₀ olefin and a (meth)acrylate ester, as described in U.S. Pat. No. 6,822,052 B2.

Thermostable cyanoacrylate adhesive bonding of, in particular, electrical, electronic, or optical components is achieved using cyanoacrylate adhesive compositions based on esters of monocyanoacrylic acid having the general formula

H₂C═C(CN)—CO—O—R

in which R is an alkyl, alkenyl, cycloalkyl, aryl, alkoxyalkyl, aralkyl, or haloalkyl group, the adhesive composition containing diisocyanates and bisphenols, as described in EP 1 005 513 B1.

A further preferred adhesive composition contains a cyanoacrylate component and an acceleration component that is made up substantially of calixarenes, oxacalixarenes, or a combination thereof, and additionally at least one crown ether. Adhesives of this kind are described in U.S. Pat. No. 6,475,331 B1.

A further advantageous cyanoacrylate adhesive agent composition having decreased adhesion to skin has a content of at least one compound of the following groups A to D and an anionic polymerization accelerator:

A: aliphatic alcohol having an aliphatic group in which 6 or more carbon atoms are directly joined to one another;

B: aliphatic carboxylic acid ester having an aliphatic group in which 6 or more carbon atoms are directly joined to one another;

C: aliphatic carboxylic acid ester having at least two aliphatic groups in which 4 or more carbon atoms are directly joined to one another; and

D: carboxylic acid ester of a carbocyclic compound that comprises, in a carboxylic-acid radical or alcohol radical, an aliphatic group in which 5 or more carbon atoms are directly joined to one another.

These adhesives are described in German Patent Application DE 43 17 886 A1.

Accelerated curing of the cyanoacrylate adhesives can be achieved by the use of organic compounds that comprise the structural element

—N═C—S—S—C═N—

as activators, as described in WO 00/39229.

In addition to the cyanoacrylate adhesives, compositions that contain as binding agent a polyurethane binding agent based on at least one polyisocyanate and at least one polyol and/or polyamine are a further advantageous embodiment of the composition according to the present invention. They are suitable for the manufacture of adhesives and molding compounds. The molding compounds can be compact compounds or, if they additionally contain a propellant, foamed materials. The binding agents can be one- or two-component polyurethane binding agents.

The two-component polyurethane binding agents are made up substantially of a reaction product of at least one polyol or polyamine with at least one polyisocyanate, at least one carboxylic acid and, if applicable, water also being added for the manufacture of foamed materials, as a propellant for pore formation. Instead of polyols or polyamines and carboxylic acids, hydroxycarboxylic acids or aminocarboxylic acids can also be used; their functionality can also be greater than 1.

The polyisocyanates are polyfunctional. The suitable polyfunctional isocyanates by preference contain on average 2 to at most 5, by preference up to 4, and in particular 2 or 3, NCO groups. Examples that may be cited as suitable isocyanates are phenyl diisocyanate, 1,5-naphthylene diisocyanate, 4,4′-diphenylmethane diisocyanate (MDI), hydrogenated MDI (H₁₂ MDI), xylylene diisocyanate (XDI), m- and p-tetramethylxylylene diisocyanate (TMXDI), 4,4′-diphenyldimethylmethane diisocyanate, di- and tetraalkyldiphenylmethane diisocyanate, 4,4′-dibenzyl diisocyanate, 1,3-phenylene diisocyanate, 1,4-phenylene diisocyanate, the isomers of toluoylene diisocyanate (TDI), in a mixture if applicable, 1-methyl-2,4-diisocyanatocyclohexane, 1,6-diisocyanato-2,2,4-trimethylhexane, 1,6-diisocyanato-2,4,4-trimethylhexane, 1-isocyanatomethyl-3-isocyanato-1,5,5-trimethylcyclohexane (IPDI) chlorinated and brominated diisocyanates, phosphorus-containing diisocyanates, 4,4′-diisocyanatophenylperfluorethane, tetramethoxybutane 1,4-diisocyanate, butane 1,4-diisocyanate, hexane 1,6-diisocyanate (HDI), dicyclohexylmethane diisocyanate, cyclohexane 1,4-diisocyanate, ethylene diisocyanate, phthalic acid bis-isocyanatoethyl ester, also polyisocyanates having reaction-capable halogen atoms, such as 1-chloromethyl phenyl 2,4-diisocyanate, 1-bromomethyl phenyl 2,6-diisocyanate, 3,3-bis-chloromethyl ether 4,4′-diphenyl diisocyanate. Sulfur-containing polyisocyanates are obtained by, for example, reacting 2 mol hexamethylene diisocyanate with 1 mol thioglycol or dihydroxydihexyl sulfide. Further important diisocyanates are trimethylhexamethylene diisocyanate, 1,4-diisocyanatobutane, 1,12-diisocyanatododecane, and dimer fatty acid diisocyanate.

Partially capped polyisocyanates that enable the formation of self-crosslinking polyurethanes are of interest, for example dimeric toluylene diisocyanate, or polyisocyanates partially or completely reacted with, for example, phenols, tertiary butanol, phthalamide, or caprolactam.

In a particular embodiment, the isocyanate component contains portions of dimer fatty acid isocyanate. “Dimer fatty acid” refers to a mixture of predominantly C₃₆ dicarboxylic acids that is manufactured by thermal or catalytic dimerization of unsaturated C₁₈ monocarboxylic acids, such as oleic acid, tall oil fatty acid, or linoleic acid. Dimer fatty acids of this kind have long been known to the skilled artisan, and are commercially available. The dimer fatty acid can be converted into dimer fatty acid isocyanates. Technical dimer fatty acid diisocyanate possesses, on average, at least two and fewer than three isocyanate groups per molecule of dimer fatty acid. The isocyanate component a) comprises by preference more than 30 wt %, in particular at least predominantly, by preference entirely, aromatic isocyanates such as MDI.

Aromatic isocyanates are generally preferred, likewise oligomerized NCO-end-position adducts of the aforesaid isocyanates and polyols, polyamines, or aminoalcohols. Aliphatic and cycloaliphatic isocyanates are also, however, capable of reacting quickly and completely even at room temperature.

Lastly, prepolymers can also be used, i.e., oligomers having multiple isocyanate groups. They are obtained, as is known, with a large excess of monomeric polyisocyanate in the presence of, for example, diols. Isocyanuratization products of HDI, and biuretization products of HDI, are also possible.

The di- or polyisocyanates used are by preference the aromatic isocyanates, e.g., diphenylmethane diisocyanate, either in the form of the pure isomers, as an isomer mixture of the 2,4′- and 4,4′-isomers, or the diphenylmethane diisocyanate (MDI) liquefied with carbodiimide that is known, for example, under the trade name Isonate 143 L®, as well as so-called “crude MDI,” i.e., the isomer/oligomer mixture of MDI obtainable, for example, under the trade name PAPI® or Desmodur VK®. In addition, so-called “quasi-prepolymers,” i.e., reaction products of MDI or of toluoylene diisocyanate (TDI) with low-molecular-weight diols such as, for example, ethylene glycol, diethylene glycol, propylene glycol, dipropylene glycol, or triethylene glycol, can be used.

Suitable polyols for the binding agent are, by preference, liquid polyhydroxy compounds, in particular having two or three hydroxyl groups per polyether and/or polyester molecule, such as, e.g., di- and/or trifunctional polypropylene glycols in the molecular weight range from 200 to 6000, by preference in the range from 400 to 3000. Statistical and/or block copolymers of ethylene oxide and propylene oxide can also be used. A further group of polyether polyols to be used by preference are the polytetramethylene glycols, which are manufactured, e.g., by acid polymerization of tetrahydrofuran. The molecular weight range of the polytetramethylene glycols is between 200 and 6000, by preference in the range from 40 to 4000.

Also suitable as polyols are the liquid polyesters that can be manufactured by the condensation of di- or tricarboxylic acids such as, for example, adipic acid, sebacic acid, and glutaric acid with low-molecular-weight diols or triols such as, for example, ethylene glycol, propylene glycol, diethylene glycol, triethylene glycol, dipropylene glycol, 1,4-butanediol, 1,6-hexanediol, glycerol, or trimethylolpropane.

A further group of polyols to be used according to the present invention are the polyesters based on ε-caprolactone, also called “polycaprolactones.”

Polyester polyols of oleochemical origin can, however, also be used. Such polyester polyols can be manufactured, for example, by complete ring opening of epoxidized triglycerides of a fat mixture containing at least partially olefinically unsaturated fatty acid with one or more alcohols having 1 to 12 carbon atoms, and subsequent partial transesterification of the triglyceride derivative to yield alkyl ester polyols having 1 to 12 carbon atoms in the alkyl radical. Further suitable polyols are polycarbonate polyols and dimer diols (available from Henkel KGaA), and in particular castor oil and derivatives thereof. Hydroxyfunctional polybutadienes, such as those obtainable e.g. under the trade name “Polybd®,” can also be used as polyols for the compositions according to the present invention.

The polyol component is, in particular, a diol/triol mixture of polyether polyols and polyester polyols.

A “propellant” is understood not only as propellant gases but also as those substances that develop propellant gases when acted upon by heat or chemicals. In the present case, the carboxylic acids react with isocyanates in the presence of catalysts to yield amides, releasing CO₂.

“Carboxylic acids” are understood as acids that contain one or more, by preference up to three, carboxyl groups (—COOH) and at least 2, by preference 5 to 400 carbon atoms. The carboxyl groups can be joined to saturated or unsaturated, linear or branched alkyl or cycloalkyl radicals, or to aromatic radicals. They can contain further groups such as ether, ester, halogen, amide, amino, hydroxy, and urea groups. Preferred, however, are carboxylic acids that can easily be incorporated as liquids at room temperature, such as natural fatty acids or fatty acid mixtures, COOH-terminated polyesters, polyethers, or polyamides, dimer fatty acids, and trimer fatty acids. Concrete examples of the carboxylic acids are: acetic acid, valeric, hexanoic, octanoic, decanoic, lauric, myristic, palmitic, stearic, isostearic, isopalmitic, arachidic, behenic, cerotic, and melissic acids, and the mono- or polyunsaturated acids palmitoleic, oleic, elaidic, petroselic, erucic, linoleic, linolenic, and gadoleic acids. The following may also be mentioned: adipic acid, sebacic acid, isophthalic acid, terephthalic acid, trimellitic acid, phthalic acid, hexahydrophthalic acid, tetrachlorophthalic acid, oxalic acid, muconic acid, succinic acid, fumaric acid, ricinoleic acid, 12-hydroxystearic acid, citric acid, tartaric acid, di- or trimerized unsaturated fatty acids, if applicable mixed with monomeric unsaturated fatty acids and, if applicable, partial esters of said compounds. Esters of polycarboxylic acids or carboxylic acid mixtures that possess both COOH and OH groups can also be used, such as esters of TMP [C₂H₅—C(CH₂OH)₃], glycerol, pentaerythritol, sorbitol, glycol, or alkoxylates thereof with adipic acid, sebacic acid, citric acid, tartaric acid, or grafted or partially esterified carbohydrates (sugar, starch, cellulose) and ring-opening products of epoxides with polycarboxylic acids.

Included among the “carboxylic acids,” in addition to the aminocarboxylic acids, are preferably “hydroxycarboxylic acids.” “Hydroxycarboxylic acids” are to be understood as monohydroxymonocarboxylic acids, monohydroxypolycarboxylic acids, polyhydroxymonocarboxylic acids, and polyhydroxypolycarboxylic acids, including the corresponding hydroxyalkoxylcarboxylic acids, having 2 to 600, by preference 8 to 400, and in particular 14 to 120 carbon atoms, which contain 1 to 9, by preference 2 to 3, hydroxyl groups or carboxyl groups on an H—C radical, in particular on an aliphatic radical. The polyhydroxymonocarboxylic acids and the polyhydroxypolycarboxylic acids, including the corresponding hydroxyalkoxycarboxylic acids, are grouped into the polyhydroxy fatty acids. The dihydroxy fatty acids used by preference, as well as the manufacture thereof, are described in German Patent Application DE-OS 33 18 596 and in EP 237 959, to which reference is expressly made.

The polyhydroxy fatty acids used are preferably derived from naturally occurring fatty acids. They therefore, as a rule, comprise an even number of carbon atoms in the main chain, and are not branched. Those having a chain length from 8 to 100, in particular from 14 to 22 carbon atoms are particularly suitable. For technical applications, natural fatty acids are usually used as technical mixtures. These mixtures by preference contain an oleic acid portion. They can furthermore contain additional saturated, monounsaturated, and polyunsaturated fatty acids. In the manufacture of the polyhydroxy fatty acids or polyhydroxyalkoxy fatty acids usable according to the present invention, it is again possible, in principle, to use mixtures of different chain lengths, which can also additionally contain saturated components or polyhydroxyalkoxycarboxylic acids having double bonds. It is therefore not only the pure polyhydroxy fatty acids that are suitable here, but also mixed products obtained from animal fats or vegetable oils that exhibit, after preparation (ester cleaving, purification steps), concentrations of monounsaturated fatty acids greater than 40%, by preference greater than 60%. Examples thereof are commercially obtainable natural raw materials such as, for example, beef tallow having a chain distribution of 67% oleic acid, 2% stearic acid, 1% heptadecanoic acid, 10% saturated acids of chain length C₁₂ to C₁₆, 12% linoleic acid, and 2% saturated acids >C₁₋₈ carbon atoms, or, for example, new sunflower oil having a composition of approx. 80% oleic acid, 5% stearic acid, 8% linoleic acid, and approx. 7% palmitic acid. These products can be briefly distilled after ring opening in order to reduce the unsaturated fatty acid ester concentrations. Additional purification steps (e.g. longer-duration distillation) are also possible.

The polyhydroxy fatty acids that are used are preferably derived from monounsaturated fatty acids, e.g., from 4,5-tetradecenoic acid, 9,10-tetradecenoic acid, 9,10-pentadecenoic acid, 9,10-hexadecenoic acid, 9,10-heptadecenoic acid, 6,7-octadecenoic acid, 9,10-octadecenoic acid, 11,12-octadecenoic acid, 11,12-eicosenoic acid, 11,12-docosenoic acid, 13,14-docosenoic acid, 15,16-tetracosenoic acid, and 9,10-ximenic acid. Of these, oleic acid (9,10-octadecenoic acid) is preferred. Both cis- and trans-isomers of all the aforesaid fatty acids are suitable.

Also suitable are polyhydroxy fatty acids that are derived from less frequently occurring unsaturated fatty acids, such as decyl-12-enoic acid, dodecyl-9-enoic acid, ricinoleic acid, petroselic acid, vaccenic acid, eleostearic acid, punicinic acid, licanic acid, parinaric acid, gadoleic acid, arachidonic acid, 5-eicosenoic acid, 5-docosenoic acid, cetoleic acid, 5,13-docosadienoic acid, and/or selacholeic acid.

Additionally suitable are polyhydroxy fatty acids that have been manufactured from isomerization products of natural unsaturated fatty acids. The polyhydroxy fatty acids manufactured in this fashion differ only in terms of the location of the hydroxy or hydroxyalkoxy groups in the molecule. They generally exist as mixtures. Naturally occurring fatty acids are preferred in the context of natural raw materials for the present invention as starting components, but this does not mean that synthetically manufactured carboxylic acids having corresponding C-numbers are not also suitable.

A hydroxyalkoxy radical of the polyhydroxy fatty acids is derived from the polyol that was used for ring opening of the epoxidized fatty acid derivative. Polyhydroxy fatty acids whose hydroxyalkoxy group derives from, by preference, primary difunctional alcohols having up to 24, in particular up to 12 carbon atoms are preferred. Suitable diols are propanediol, butanediol, pentanediol and hexanediol, dodecanediol, by preference 1,2-ethanediol, 1,4-butanediol, 1,6-hexanediol, polypropylene glycol, polybutanediol, and/or polyethylene glycol having a degree of polymerization from 2 to 40. Also particularly suitable as diol compounds are polypropylene glycol and/or polytetrahydrofurandiol, and mixed polymerization products thereof. This especially the case when these compounds respectively exhibit a degree of polymerization from approximately 2 to 20 units. Triols or even higher-valence alcohols can also be used for ring opening, however, for example glycerol and trimethylolpropane, as well as adducts thereof of ethylene oxide and/or propylene oxide having molecular weights up to 1500. Polyhydroxy fatty acids having more than 2 hydroxyl groups per molecule are then obtained.

A hydrocarboxylic acid, e.g., citric acid, ricinoleic acid, 12-hydroxystearic acid, or lactic acid, can also be used, instead of a polyol, as a hydroxyl group-containing compound for ring opening. Ester groups, rather than ether groups, are then produced. Amines, hydroxyl group-carrying amines, or aminocarboxylic acids can additionally be used for ring opening.

Dihydroxy fatty acids, manufactured in particular from epoxidized unsaturated fatty acids and diols, are, however, preferred. They are liquid at room temperature and can easily be mixed with the other reaction participants. “Dihydroxy fatty acids” are understood for purposes of the invention as both the ring-opening products of epoxidized unsaturated fatty acids with water, and also the corresponding ring-opening products with diols and their crosslinking products with further epoxide molecules. The ring-opening products with diols can also be referred to somewhat more accurately as dihydroxyalkoxy fatty acids.

The hydroxy groups or hydroxyalkoxy group are by preference separated from the carboxy group by at least one, by preference at least 3, in particular at least 6 CH₂ units.

Preferred dihydroxy fatty acids are: 9,10-dihydroxypalmitic acid, 9,10-dihydroxystearic acid, and 13,14-dihydroxybehenic acid, as well as their respective 10,9- and 14,13-isomers.

Polyunsaturated fatty acids are also suitable, e.g., linoleic acid, linolenic acid, and ricininic acid.

Cinnamic acid may be named as a concrete example of an aromatic carboxylic acid.

Carboxylic acids that can be manufactured from fats are preferred.

If CO₂ release is to start already at room temperature, it is useful to use amino-substituted pyridines and/or N-substituted imidazoles as catalysts. 1-Methylimidazole, 2-methyl-1-vinylimidazole, 1-allylimidazole, 1-phenylimidazole, 1,2,4,5-tetramethylmidazole, 1(3-aminopropyl)imidazole, pyrimidazole, 4-dimethylaminopyridine, 4-pyrrolinopyridine, 4-morpholinopyridine, 4-methylpyridine, and N-dodecyl-2-methylimidazole are particularly suitable.

The aforementioned starting materials for the polyurethane binding agent, namely polyisocyanate, polyol, polyamides, carboxylic acids, and substances having at least one hydroxyl, amine, or carboxyl group, as well as catalysts, are used in the following quantitative ratios: one equivalent of isocyanate is accompanied by 0.1 to 1, by preference 0.1 to 0.8 equivalents of a mixture of carboxylic acid and alcohol, and 0.0001 to 0.5, by preference 0.001 to 0.1 equivalents of amine catalyst, such that the alcohol:acid ratio can be 20:1 to 1:20. For the case in which no alcohol or polyamine participates in the reaction, i.e. the isocyanates are reacted with the carboxylic acids, the rule is as follows: one equivalent of isocyanate is accompanied by 0.1 to 4, by preference 0.8 to 1.4 equivalents of carboxylic acid, and 0.0001 to 0.5, by preference 0.001 to 0.1 equivalents, of tertiary amine catalyst. If polycarboxylic acids or hydroxy- or aminocarboxylic acids are used, the addition of polyols can therefore be entirely dispensed with.

In the event the polyvalent isocyanates are reacted predominantly with hydroxycarboxylic acids, the amines should by preference be used at a concentration from 0.05 to 15, in particular from 0.5 to 10 wt %, based on the sum of hydroxycarboxylic acid and isocyanate.

In addition to the aforementioned pyridine and imidazole derivatives, further catalysts can also be added, especially organometallic compounds such as tin(II) salts of carboxylic acids, strong bases such as alkali hydroxides, alkali alcoholates, and alkali phenolates, e.g. di-n-octyl tin mercaptide; dibutyl tin maleate, diacetate, dilaurate, dichloride, and bisdodecyl mercaptide; tin(II) acetate, ethylhexoate, and diethylhexoate; or lead phenyl ethyl dithiocarbaminate. The organometallic catalysts can also be used alone if certain carboxylic acids are utilized, namely hydroxy- and aminocarboxylic acids. DABCO TMR-2® etc. of the Air Products company may be mentioned as a trimerization catalyst, this being quaternary ammonium salts dissolved in ethyl glycol.

Also additionally suitable are aliphatic tertiary amines, in particular with a cyclic structure. Also suitable among the tertiary amines are those that additionally carry groups that are reactive with respect to the isocyanates, in particular hydroxyl and/or amino groups. Concretely, the following may be mentioned: dimethylmonoethanolamine, diethylmonoethanolamine, methylethylmonoethanolamine, triethanolamine, trimethanolamine, tripropanolamine, tributanolamine, trihexanolamine, tripentanolamine, tricyclohexanolamine, diethanol/methylamine, diethanolethylamine, diethanolpropylamine, diethanolbutylamine, diethanolpentylamine, diethanolhexylamine, diethanolcyclohexylamine, diethanolphenylamine, and their ethoxylation and propoxylation products, diazabicyclooctane (Dabco®), triethylamine, dimethylbenzylamine (Desmorapid DB®, BAYER), bisdimethylaminoethyl ether (Catalyst A I®, UCC), tetramethylguanidine, bisdimethylaminomethylphenol, 2,2′-dimorpholinodiethyl ether, 2-(2-dimethylaminoethoxy)ethanol, 2-dimethylaminoethyl-3-dimethylaminopropyl ether, bis(2-dimethylaminoethyl)ether, N,N-dimethylpiperazine, N-(2-hydroxyethoxyethyl)-2-azanorborane, Texacat DP-914® (Texaco Chemical), N,N,N,N-tetramethylbutane-1,3-diamine, N,N,N,N-tetramethylpropane-1,3-diamine, and N,N,N,N-tetramethylhexane-1,6-diamine.

The catalysts can also be present in oligomerized or polymerized form, e.g., as N-methylated polyethyleneimine.

When water is used as an additional propellant or chain-extending agent, it may be useful to use an aliphatic tertiary amine as catalyst. As a rule, water is then utilized in a quantity from 0.1 to 15, in particular from 0.3 to 5 wt %, based on the polyurethane.

When the isocyanates react with H₂O, as a result of the carboxylic acid/isocyanate reaction the polyurethane binding agents of the shaped element also have urea groups in addition to the amide group. They additionally contain urethane groups when the isocyanates react with polyols, with polyhydroxycarboxylic acids, or with cellulose; and they additionally contain ester groups when the carboxylic acids and alcohols react.

The quantity of reaction partners (polyisocyanate, polyol, and carboxylic acid) is selected so that an excess of polyisocyanate is utilized. In other words, an equivalence ratio of NCO to OH groups of 5:1, but by preference from 2:1 to 1.2:1, exists; an isocyanate excess from 5 to 50% is very particularly preferred.

The compositions containing a two-component polyurethane binding agent can advantageously contain wood particles and/or cellulose-containing material as a further filler in addition to the glass particles. These substances are well suited to the manufacture of shaped elements. They are described, for example, in German Patent DE 197 56 154 C1 and European Patent EP 0 839 083 B1.

According to a further advantageous embodiment, the compositions can contain as a binding agent a dispersion based on polyvinyl acetate, polyacrylate, polybutadiene styrene, polyvinylidene, polyurethane, polychloroprene, rubber, vinyl acetate/acrylate copolymers, maleinates, or polyolefins. These substances are suitable as so-called dispersion adhesives.

The compositions according to the present invention can advantageously also contain, as a binding agent, a hot melt adhesive that is selected by preference from the group comprising pressure-sensitive adhesives, polyolefins, ethylene/vinyl acetate copolymers, polyamides, polyurethanes, silane-terminated polyurethanes, and silane-terminated polyamides.

A moisture-curing polyurethane hot melt adhesive is described, for example, in German Patent DE 698 07 928 T2. Moisture-curing or moisture-crosslinking polyurethane hot melt adhesives are adhesives that are solid at room temperature and are applied in the form of a melt, their polymer components encompassing urethane groups and reactive isocyanate groups. Cooling of the melt causes firstly a rapid physical setting of the adhesive, followed by a chemical reaction between the isocyanate groups that are still present and moisture, yielding a crosslinked adhesive that now cannot be melted. Only after this chemical curing with moisture, which is accompanied by an increase in molecule size and/or crosslinking, does the adhesive assume its final properties. Polyurethane hot melt adhesives in the narrower sense are substantially solvent-free. The polyurethane hot melt adhesive composition known from the aforesaid patent encompasses the product of combining the following constituents:
a) 95 to 3 wt % of the reaction product of a first polyisocyanate and a polymer of ethylenically unsaturated monomers having a molecular weight below 60,000, said polymer comprising active hydrogen groups and not being a copolymer of ethylene, vinyl acetate, and an ethylenically unsaturated monomer having at least one primary hydroxyl group;
b) 5 to 90 wt % of at least one polyurethane prepolymer having free isocyanate groups, manufactured from at least one polyol from the group of the polyester diols, polyester triols, polyester polyols, aromatic polyols, and mixtures thereof, and at least one second polyisocyanate that can be identical to or different from the first polyisocyanate; and
c) 0 to 40 wt % of at least one additive from the group of the catalysts, tackifiers, plasticizers, fillers, pigments, stabilizers, adhesion improvers, rheology improvers, and mixtures thereof, in such a way that the sum of a), b), and c) yields a total of 100%.

In a further advantageous embodiment of the invention, the compositions can contain epoxy resins as binding agents. These can be standard epoxy resins in combination with the known hardeners, for example polyamines. The compositions can, however, also contain modified epoxy resins or specific further constituents, as described below. The addition according to the present invention of glass particles results in toughening, and fracture resistance, modulus of elasticity, and shear modulus, as well as electrical properties, are improved.

A preferred composition whose properties are improved by the glass particles is described in European Patent EP 1 272 587 B1. The composition contains
A) at least one epoxy resin having an average of more than one epoxide group per molecule;
B) a copolymer having a glass transition temperature of −30° C. or lower and groups reactive with respect to epoxides, or a reaction product of said copolymer with a stoichiometric excess of an epoxy resin according to A);
C) a latent hardener, activatable at elevated temperature, for component A); and either
D) a reaction product producible from a difunctional amino-terminated polymer and a tri- or tetracarboxylic acid anhydride, characterized by an average of more than one imide group and carboxyl group per molecule; or
E) a reaction product producible from a tri- or polyfunctional polyol or a tri- or polyfunctional amino-terminated polymer and a cyclic carboxylic acid anhydride, the reaction product containing on average more than one carboxyl group per molecule; or
F) a mixture of the reaction products according to D) and E).

The compositions are usable as a high-strength, impact-resistant structural adhesive in vehicle construction, aircraft construction, or rail vehicle construction. With them, internal stiffening members of cavities can be constituted in vehicle construction, and stiffening coatings can be manufactured for thin-walled panels or plastic components. The compounds are further suitable as composite materials, as sealing compounds in the electrical and electronic industry, and as adhesives in the manufacture of circuit boards in the electronic industry.

A further preferred composition encompasses, according to European Patent Application EP 1 359 202 A1, at least one epoxy resin A having an average of more than one epoxide group per molecule, at least one epoxide adduct B each having an average of more than one epoxide group per molecule, at least one thixotroping agent C based on a urea derivative in a non-diffusing carrier material, and at least one hardener D for epoxy resins, which is activated by elevated temperature. Epoxy resin A is a liquid resin, in particular a bisphenol A diglycidyl ether, bisphenol F diglycidyl ether, or bisphenol A/F diglycidyl ether. Epoxide adduct B is advantageously an epoxide adduct B1 that is obtainable from at least one dicarboxylic acid and at least one diglycidyl ether and is combined, as applicable, with an epoxide adduct B2 that is obtainable from at least one bis(aminophenyl)sulfone isomer or at least one aromatic alcohol and at least one diglycidyl ether. Hardener D can be a latent hardener from the group of dicyandiamide, guanamines, guanidines, and aminoguanidines. The compositions are one-component, heat-curing compositions, in particular adhesives and hot melt adhesives, that are stable at room temperature and that exhibit on the one hand high strength and on the other hand a high glass transition temperature. They are suitable for adhesive bonding of vehicle parts.

A further epoxy composition that is described in U.S. Pat. No. 6,486,256 BI encompasses a chain extender, a basic catalyst, a reactive epoxy resin that is not substantially chain-extended, and a polymeric toughener.

European Patent EP 0 308 664 B1 further discloses modified epoxy resins whose properties can likewise be improved by addition of the glass particles. These are mixtures of specific diene copolymers and phenol-terminated polyurethanes or polyureas, mixtures of this type containing epoxy resins, and/or adducts of epoxy resins with the diene copolymer and/or the polyurethane or polyurea. The copolymers are based on at least one 1,3-diene and at least one polar, ethylenically unsaturated comonomer. Highly flexible products result upon curing of these compositions.

Reactive hot melt adhesives can also be manufactured on the basis of epoxy resins. European Patent EP 0 591 307 B1 describes one such hot melt adhesive which contains one or more epoxy resin components, at least one thermally activatable latent hardener for the resin component, and (if applicable) accelerators, fillers, thixotropy adjuvants, and further usual additives, the resin component being a reaction product of 0.5 to 1 equivalents of an epoxy resin, solid at room temperature and manufactured from bisphenol A and/or bisphenol F and epichlorohydrin, having an epoxide equivalent weight from 400 to 700, 0.5 to 1 equivalents of an epoxy resin, liquid at room temperature and manufactured from bisphenol A and/or bisphenol F and epichlorohydrin, having an epoxide equivalent weight from 150 to 220, and 0.125 to 0.5 equivalents of amino-terminated polyethylene glycols or polypropylene glycols. The epoxy resins are present in a quantity such that a stoichiometric excess of at least one equivalent of epoxy groups with respect to the amino groups is ensured. The hot melt adhesives exhibit sufficient flexibility and elevated peel resistance not only at room temperature but also at low temperatures below 0° C. This improvement is achieved with no impairment of tensile shear strength. The reactive hot melt adhesives moreover have sufficient wash-out resistance prior to curing.

U.S. Patent Application US 2003/0196753 A1 furthermore discloses curable adhesives that contain the following constituents: an epoxy-based prepolymer that is the reaction product of an epoxy resin and a reaction partner that is selected from the group comprising amino-terminated polyethers, resins based on carboxyl group-containing 1,3-dienes, and polar unsaturated comonomers and mixtures thereof, and additionally an acrylic-terminated urethane resin that is the reaction product of a polyfunctional isocyanate, a polyol, and an isocyanate of reactive (meth)acrylate, and additionally a heat-activatable latent hardener. The cured products have improved impact toughness and a wide range of possible applications.

U.S. Pat. No. 6,632,893 B2 discloses a heat-curing resin composition that contains approx. 100 parts of an epoxy resin component, up to 30 parts of a latent hardener that contains a cyanate ester component and an imidazole component, and contains a toughening component based on a polysulfide. The compositions are suitable for adhesive bonding of electronic parts.

U.S. Pat. No. 6,911,109 B2 describes a two-component composition, curable at room temperature, that contains as a first component an epoxy resin and a (meth)acrylate component, and as a second component an epoxy resin hardener and a catalyst based on a transition metal complex. The second component further contains an accelerator that is selected from the group comprising nonylphenol, dinonylphenol, piperazine, triethanolamine, water, alcohols, acids, and salts and combinations thereof.

A further group of products that can be improved according to the present invention by the addition of glass particles are sealing compounds. These are compositions that contain as a binding agent silicones, silane-curing polymers, modified silicones (MS polymers), polysulfides, polyurethanes, rubber, polyacrylates, dispersion sealants, polyvinyl chloride, and/or other plastisols.

An important group of sealing compounds is room temperature vulcanizing silicone rubber compositions that contain a polyorganosiloxane base polymer having silanol terminal groups, a crosslinker comprising alkylacyloxysilanes and/or -siloxanes, and a particulate filler.

Room temperature vulcanizing silicone rubber compositions (RTV compositions) are well known in the art. They are described, for example, in European Patent EP 1 013 715 B1. The compositions are generally made up of: a polyorganodisiloxane polymer with silanol terminal groups; a silicon dioxide filler; an organotriacyloxysiiane as crosslinking agent; and a metal salt of a carboxylic acid as catalyst. The compositions cure at room temperature, by the action of moisture that is generally present in the atmosphere, to a solid elastic state. RTV silicone compositions are very useful for sealing and caulking applications in which excellent adhesion to various surfaces is important. Such applications require that the compositions be applied into cracks or onto surfaces that have a vertical orientation or are located overhead. It is therefore important that such compositions have viscosity and adhesion properties that allow them to be applied freely into or onto cracks and surfaces.

Silicon dioxide is used in many RTV silicone compositions as an essential agent for controlling rheology. Silicon dioxide has, however, certain disadvantages in these sealing compounds as well. On the one hand, this material is relatively expensive, and on the other hand it can be added to the silicone rubber composition, for practical use, only up to a concentration of approximately 20 wt %. If larger quantities are used, the viscosity of the compositions rises so much that they are no longer processable.

In silicone rubber compositions as well, complete or partial replacement of finely particulate silicon dioxide with glass particles that have been obtained by the comminution of foamed glass results in improved technical properties. The glass powder can be used up to a concentration of approx. 70 wt %. It is to be regarded as surprising that the glass powder does not lead to destruction of the polymer matrix, but rather vulcanizes to yield a low-modulus, highly extensible, highly elastic rubber. This rubber exhibits self-extinguishing properties, i.e. it is flammable, but the flames extinguish themselves after a short time. Surprisingly, the tearing strength of the rubber is greatly increased as the filler content rises.

A further sealing compound whose properties can be improved, according to the present invention, by the incorporation of glass-foam powder, is described in German Patent DE 38 16 808 C1. These are one-component molding and sealing compounds based on prepolymers that contain silyl terminal groups having at least one hydrolyzable substituent on the Si atom, organometallic tin compounds as a catalyst, and inorganic fillers. The compound contains an isocyanate and/or a carboxylic acid chloride, in a quantity from 0.01 to 1 wt %, as stabilizer. The stabilizer is advantageously p-toluoyl sulfonyl isocyanate.

German Patent Application DE 196 53 388 A1 discloses a compressively elastic, foamable sealant based on silane-modified polymers. In the known composition, highly dispersed silicic acid is used as a filler. Said acid can be partially or entirely replaced by glass-foam powder.

Also known, from German Patent Application DE 195 17 452 A1, is a two-component adhesive/sealant having high initial adhesion. The first component contains a one-component, moisture-curing adhesive/sealant, and the second component contains a crosslinker and/or accelerator for the first component.

Suitable organopolysiloxane compounds with which the present invention can be realized are also described in European Patent EP 0 940 445 B1. These are RTV-1 compounds that are based on an α,ω-dihydroxylpolydiorganosiloxane, a filler, and further constituents as applicable. The silicic acid used in the known compounds can advantageously be at least partially replaced by glass-foam powder.

U.S. Pat. No. 3,677,996 discloses a room temperature curing silicone rubber compound that contains siloxane elastomers, a nitrogen-containing crosslinking agent, and a polyglycol. With this composition as well, the addition of glass-foam powder improves the technical properties of the product.

German Patent DE 699 06 232 T2 discloses a room temperature vulcanizing one-component silicone rubber composition that contains the following constituents:
(A) 100 parts by weight of a polyorganosiloxane base polymer having silanol terminal groups and a viscosity within a range from 200 to 500,000 mPa·s at 25° C., which contains an average of 1.85 to 2 organic radicals per silicon atom and contains 0.02 wt % to 2 wt % silicon-bound hydroxyl radicals;
(B) 0.5 to 10 parts by weight of an organotriacyloxysilane crosslinking agent described by the formula R²Si(OY)₃, in which R² is a monovalent hydrocarbon radical having 1 to 18 carbon atoms and each Y is an independently selected saturated monoacyl radical of a carboxylic acid; and
(C) 0.2 to 10 parts by weight of a polysiloxane-polyether copolymer described by the formula R³Si((OSiR³₂)ₓOSiR³₂R⁴)₃, in which each R³ is an independently selected monovalent hydrocarbon radical having 1 to 18 carbon atoms, x=0 to 1000, and R⁴ is described by the formula —(CH₂)ₐO(CH₂CH₂O)_{b}(CH₂OHR⁵O)_{c}R⁶, in which R⁵ is an alkyl radical having 1 to 6 carbon atoms, R⁶ is selected from hydrogen, monovalent hydrocarbon radicals having 1 to 12 carbon atoms, and saturated monoacyl radicals of a carboxylic acid, and a=3 to 12, b=0 to 100, c=0 to 100, and b+c>0; and
(D) 1 to 70 parts by weight of particulate silicon dioxide.
   With this composition as well, the particulate silicon dioxide can be entirely or partially replaced by glass-foam powder.

WO 20051033240 A1 discloses binding agents having barrier properties that can once again advantageously contain glass-foam powder as a filler. The binding agents contain a) a compound having at least one NCO group and at least one reactive functional group curable by irradiation as component (A); and b) an organosilicon compound as component (B), having at least one NCO group and at least one functional group of formula (I): —Si(X)₃₋ₙ, where X=—NH₂; —NH—CO—R; —OOC—R; —O—N═C(R)₂ or OR′; R=a linear or branched, saturated or unsaturated C₁-C₁₈ alkyl radical, preferably a methyl, ethyl, propyl, or isopropyl radical; R′=R, preferably a methyl, ethyl, propyl, or isopropyl radical; or an oxyalkylene radical having up to 4 carbon atoms, preferably —(C₂H₄—O)ₘ—H and/or (CH₂—CH(CH₃)—O)ₘ—H; a C₅-C₈ cycloalkyl radical; a C₆-C₁₀ aryl radical, or a C₇-C₁₂ aralkyl radical; m=1 to 40, preferably 1 to 20, particularly preferably 1 to 10; n=0, 1, or 2. The binding agent is used as a radiation-curable binding agent in coating agents, fillers, sealants, or adhesives. Composite films having barrier properties with respect to CO₂, O₂, N₂, water vapor, and aroma chemicals can also be manufactured using the binding agents.

Compositions having binding agent barrier properties can also contain
A) at least one compound that is flowable in the range from 18° C. to 100° C., preferably 20° C. to 80° C., having at least one reactive functional group curable by irradiation, as component (A);
B) at least one compound having at least one reactive functional group curable by irradiation and at least one COOH group, as component (B);
C) if applicable, a nanoscale filler as component (C), preferably selected from the group of: oxides, nitrides, halides, sulfides, carbides, tellurides, selenides of the second to fourth main group, of the transition elements, of the lanthanides, and/or from the group of the polyorganosiloxanes; and
D) glass particles that have been obtained by comminuting foamed neutral or acid glass.

The binding agent according to the present invention exhibits barrier properties with respect to CO₂, O₂, N₂, water vapor, and aroma chemicals. In the context of the preferred utilization as a sealant or adhesive, the number of production steps for the manufacture of composite materials having barrier properties is reduced, since the otherwise usual additional coatings with polyvinylidene chloride and/or ethylene-vinyl alcohol layers, or evaporative coating with aluminum layers, are no longer necessary. The absence of a metal layer makes the composite materials more uniform in terms of substance, and thus easier to dispose of. In particular, the absence of a metal layer makes possible the manufacture of transparent film composites having barrier properties.

The binding agents according to the present invention exhibit, at 60° C., a viscosity from 50 mPa·s to 52,000 mPa·s (measured with a Brookfield RVT DV-II digital viscosimeter, spindle 27), and are therefore easily applicable at low temperatures, i.e. in a range from 40° C. to 120° C., and rapidly exhibit good initial adhesion. Temperature-sensitive substrates, for example polyolefin films, can thus be securely adhesively bonded with no damage to the substrate.

The binding agent according to the present invention is radiation-curable and, in a preferred embodiment, is used as a dual-cure system. The binding agents should then be anhydrous. Dual-cure systems are notable for the fact that they are both radiation-curable and curable by way of a second, independent curing mechanism. The binding agents according to the present invention can preferably be used as one-component (1K) systems, so that the provision of additional components, in particular hardeners, can be omitted.

The adhesives, sealants, and fillers that contain the binding agent according to the present invention comprise few to no migration-capable constituents. The otherwise usual waiting times for complete curing after application of the adhesive, sealant, or filler are thus eliminated.

“Binding agents” are to be understood in the context of the present invention as those substances that join similar or differing substrates or can themselves adhere fixedly thereto.

The terms “hardening,” “curing,” or similar terms refer, in the context of the present text, to polyreactions such as those that can occur within individual components of the respective composition discussed in connection with the term. The polyreaction can be a radical, anionic, or cationic polymerization, polycondensation, or polyaddition, in which a reactive functional group can react with a suitable further functional group, with an increase in the molecular weight of the molecule carrying said group. Crosslinking reactions usually also take place simultaneously.

The “radiation-curable” feature is to be understood, in the context of the present invention, as the initiation of a polyreaction under the influence of radiation. “Radiation” is to be understood here as any kind of radiation that brings about irreversible crosslinking in the crosslinkable binding-agent layer that is to be irradiated. UV, electron beams, and visible light, but also IR radiation, are particularly suitable.

A reactive functional group curable by irradiation is, for example, a group having a carbon-carbon double bond.

Molecular weight indications referring to polymeric compounds refer, unless otherwise indicated, to the arithmetic mean of the molecular weight (Mₙ). All molecular weight indications refer, unless otherwise indicated, to values that are obtainable by gel permeation chromatography (GPC).

Monomeric, oligomeric, and polymeric compounds are used as component (A), provided they comprise at least one reactive functional group curable by irradiation. Component (A) is preferably flowable in the range from 18° C. to 100° C., preferably 20° C. to 80° C.

Compounds of this kind that are usable as component (A) are selected from the group of: polyacrylic and/or polymethacrylic acid alkyl, cycloalkyl, or aryl esters, methacrylic acid and/or acrylic acid homo- and/or copolymerizates, unsaturated polyesters, polyethers, polycarbonates, polyacetals, polyurethanes, polyolefins, vinyl polymers, or rubber polymers such as nitrile or styrene/butadiene rubber.

Compounds usable for the invention as component (A) are described, for example, in C. G. Roffey, “Photogeneration of Reactive Species for UV Curing”, John Wiley & Sons, 1997, pp. 182 (vinyl derivatives), 482-485 (unsaturated polyesters), 487-502 (polyester, polyether, epoxy, polyurethane and melamine acrylates), 504-508 (radiation-crosslinkable organopolysiloxane polymers), and in R. Holmann and P. Oldring, “U.V. and E.B. Curing Formulation for Printing Inks, Coatings and Paints”, SITA (Selective Industrial Training Associates Limited, London, U.K.), 2nd ed., 1988, on pp. 23-26 (epoxy acrylates), 27-35 (urethane acrylates), 36-39 (polyester acrylates), 39-41 (polyether acrylates), 41 (vinyl polymers), 42-43 (unsaturated polyesters).

Compounds from the group of: (meth)acrylic acid homo- and/or copolymerizates, polyester (meth)acrylates, epoxy(meth)acrylates, or polyurethane (meth)acrylates are used by preference as component (A).

The “(meth)acrylate” feature is intended here to serve as an abbreviation for “acrylate and/or methacrylate.”

Comonomers of (meth)acrylic acid that contain styrene, methyl styrene, and/or other alkyl styrenes and/or alpha-olefins as comonomers, are preferred.

Di- and/or higher-functional acrylate or methacrylate esters are particularly suitable as component (A). Acrylate or methacrylate esters of this kind preferably encompass esters of acrylic acid or of methacrylic acid with aromatic, aliphatic, or cycloaliphatic polyols, or acrylate esters of polyether alcohols. Suitable compounds are described in C. G. Roffey, “Photogeneration of Reactive Species for UV Curing” on pp. 537-560, and in R. Holmann and P. Oldring, “U.V. and E.B. Curing Formulation for Printing Inks, Coatings and Paints” on pp. 52-59.

Compounds used in particularly preferred fashion as component (A) encompass (meth)acrylate esters of aliphatic polyols having 2 to approximately 40 carbon atoms.

Compounds of this kind are preferably selected from the group of: neopentyl glycol di(meth)acrylate, 1,6-hexanediol di(meth)acrylate, trimethylolpropane tri(meth)acrylate, pentaerythritol tetra(meth)acrylate, and (meth)acrylate esters of sorbitol and of other sugar alcohols. The (meth)acrylate esters of aliphatic or cycloaliphatic diols can be modified with an aliphatic ester or an alkylene oxide. The acrylates modified with an aliphatic ester encompass, for example, neopentyl glycol hydroxypivalate di(meth)acrylate, caprolactone-modified neopentyl glycol hydroxypivalate di(meth)acrylates, and the like. The alkylene oxide-modified acrylate compounds encompass, for example, ethylene oxide-modified neopentyl glycol di(meth)acrylates, propylene oxide-modified neopentyl glycol di(meth)acrylates, ethylene oxide-modified 1,6-hexanediol di(meth)acrylates, or propylene oxide-modified 1,6-hexanediol di(meth)acrylates, or mixtures of two or more thereof.

Acrylates or methacrylates that contain aromatic groups are also usable. These include corresponding bisphenol A compounds, for example diacrylates or dimethacrylates of adducts of bisphenol A with alkylene oxides, e.g. adducts of bisphenol A with ethylene oxide and/or propylene oxide.

Acrylate comonomers constructed on polyether polyols encompass, for example, neopentyl glycol-modified (meth)acrylates, trimethylolpropane di(meth)acrylates, polyethylene glycol di(meth)acrylates, polypropylene glycol di(meth)acrylates, and the like. Tri- and higher-functional acrylate monomers encompass, for example, trimethylolpropane tri(meth)acrylate, pentaerythritol tri- and tetra(meth)acrylate, dipentaerythritol tetra(meth)acrylate, dipentaerythritol penta(meth)acrylate, dipentaerythritol hexa(meth)acrylate, caprolactone-modified dipentaerythritol hexa(meth)acrylate, pentaerythritol tetra(meth)acrylate, tris[(meth)acryloxyethyl]isocyanurate, caprolactone-modified tris[(meth)acryloxyethyl]isocyanurates, or trimethylolpropane tetra(meth)acrylate, or mixtures of two or more thereof.

Among the aforesaid di-, tri-, and higher-functional acrylate monomers that are usable according to the present invention as component (A), di-, tri- and tetrapropylene glycol diacrylate, neopentyl glycol propoxylate di(meth)acrylate, trimethylolpropane tri(meth)acrylate, trimethylolpropane monoethoxytri(meth)acrylate, and pentaerythritol triacrylate are preferred.

(Meth)acrylate esters based on urethane group-containing polyols can be manufactured by reacting a polyol with a di- or higher-functional isocyanate to produce OH-terminated polyurethane prepolymers, which are esterified with (meth)acrylic acid to yield the corresponding diesters.

In a particularly preferred embodiment, compounds having the general formula (I) are used as component (A):

H₂C═CR¹—C(═O)—O—(R⁷—O)ₙR⁸ (I)

where

R¹=H, CH₃,

R⁷=straight-chain or branched alkylene group from C₂ to C₁₀,

R⁸=straight-chain or branched alkylene group from C₁ to C₂₅,

n=1 to 25.

Preferred compounds of the general formula (I) are methoxyethyl acrylate, ethoxymethyl methacrylate, methoxyethoxyethyl methacrylate, ethoxyethoxyethyl acrylate, butyldiethylene glycol methacrylate, ethoxylated nonylphenol acrylate, ethoxylated lauryl alcohol methacrylate, alkoxylated tetrahydrofurfuryl acrylate, methoxypolyethylene glycol monoacrylate.

Particularly preferably, component (A) is selected from the group of: hydrofunctional ethylhexyl methacrylate, octylidecyl acrylate, ethoxylated trimethylolpropane triacrylate, modified aromatic or aliphatic epoxy acrylates, neopentyl glycol di(meth)acrylate, 1,6-hexanediol di(meth)acrylate, trimethylolpropane tri(meth)acrylate, pentaerythritol tetra(meth)acrylate, neopentyl glycol hydroxypivalate di(meth)acrylate, caprolactone-modified neopentyl glycol hydroxypivalate di(meth)acrylates, ethylene oxide-modified neopentyl glycol di(meth)acrylates, propylene oxide-modified neopentyl glycol di(meth)acrylates, ethylene oxide-modified 1,6-hexanediol di(meth)acrylates, propylene oxide-modified 1,6-hexanediol di(meth)acrylates, polyethylene glycol di(meth)acrylates, polypropylene glycol di(meth)acrylates, pentaerythritol tri(meth)acrylate, dipentaerythritol tetra(meth)acrylate, dipentaerythritol penta(meth)acrylate, dipentaerythritol hexa(meth)acrylate, caprolactone-modified dipentaerythritol hexa(meth)acrylate, tris[(meth)acryloxyethyl]isocyanurate, caprolactone-modified tris[(meth)acryloxyethyl]isocyanurates, di, tri- and tetrapropylene glycol diacrylate, neopentyl glycol propoxylate di(meth)acrylate, trimethylolpropane monoethoxytri(meth)acrylate, amine-modified polyether acrylates.

The molar weight of compound (A) is in the range from 100 to 15,000 gμmol, preferably from 100 to 10,000 g/mol, and particularly preferably from 100 to 8000 g/mol. Compound (A) represents, in the radiation-curable binding agent according to the present invention having barrier properties, a proportion from 5 to 60 wt %, preferably 5 to 45 wt %, particularly preferably 5 to 30 wt %.

Acrylated carboxylic acid-terminated polyesters, carboxylic acid-modified polybutadienes, and acid-modified (meth)acrylates constructed on polyether polyols are preferably used as component (B). The latter are obtainable by reacting polyether polyols, such as ethylene glycol or propylene glycol, with aromatic or aliphatic dicarboxylic acids such as adipic acid or phthalic acid, and (meth)acrylic acid.

Used in particular as component (B) are products that are disclosed in WO 01/16244 A1, the entire content of which is expressly incorporated into the present patent application.

Preferred commercially available compounds that are used as component (B) are obtainable from the Cognis company under the trade name PHOTOMER® 5429 F, 5432, 4173, 4149, 3038 or 4017, from the BASF company under the trade name LAROMER PE 44F, PE 55F, PE 56F, 8800, 8981, 9004, from the Cray Valley company under the trade name CRAYNOR 203, 293, 294 E, UVP 210, UVP 220 or the trade name SYNOCURE AC 1007, from the Rahn company under the trade name GENOMER 6043, 6050, from the UCB company under the trade name EBECRYL 436, 438, 584, 586, 588.

The molar weight of compound (B) is in the range from 100 to 15,000 g/mol, preferably from 100 to 10,000 g/mol, and particularly preferably from 100 to 8000 g/mol. Compound (B) represents, in the radiation-curable binding agent according to the present invention having barrier properties, a proportion from 5 to 70 wt %, preferably 10 to 60 wt %, particularly preferably 20 to 40 wt %.

The binding agent can contain as component (C) a nanoscale filler that is preferably selected from the group of: oxides, nitrides, halides, sulfides, carbides, tellurides, selenides of the second to fourth main group, of the transition elements, of the lanthanides, and/or from the group of the polyorganosiloxanes.

Nanoscale fillers are also referred to as nanodispersed fillers or “nanoparticles,” since the smallest particles thereof forming a rigid unit in the dispersion exhibit, as a numerically weighted average of all particles, an extension in at least one direction arbitrarily selectable for each particle of no more than 1000 nanometers (nm), preferably no more than 500 nm, and particularly preferably no more than 100 nm.

The nanoparticles possess, for example, a spherical, rod-like, or platelet-like structure, or represent mixtures of different structures.

The nanoparticles contained in the nanoscale filler have sizes, as a numerically weighted average, preferably in the range from 1 to 40 nm, particularly preferably between 3 and 30 nm. The particle size is preferably determined using the ultrafine particle analyzer (UPA) method, for example with the laser light backscattering method. In order to prevent or eliminate agglomeration or coalescence of the nanoparticles, they can usually be surface-modified or surface-coated. One such method for manufacturing agglomerate-free nanoparticles is indicated, using the example of iron oxide particles, in DE-A-19614136 in columns 8 to 10.

Some possibilities for surface coating of such nanoparticles in order to eliminate agglomeration are indicated in DE-A-19726282. In a preferred embodiment of the invention, nanoscale fillers are used whose smallest constituents forming a rigid unit in the dispersion exhibit, in two mutually perpendicular, arbitrarily selectable directions, a respective extension of at least ten times the size of the constituents in the direction having the smallest extension of the constituent. The thickness of these particles is preferably less than 10 nm.

The nanoscale filler is selected from the group of: oxides, nitrides, halides, sulfides, carbides, tellurides, selenides of the second to fourth main group, of the transition elements, or of the lanthanides, in particular oxides, hydroxides, nitrides, halides, carbides, or mixed oxide/hydroxide/halide compounds of aluminum, silicon, zirconium, titanium, tin, zinc, iron, or of the alkali and/or alkaline earth metals. These are substantially clays, for example aluminum oxides, boehmite, bayerite, gibbsite, diaspore, and the like. Sheet silicates such as, for example, bentonite, montmorillonite, hydrotalcite, hectorite, kaolinite, boehmite, mica, vermiculite, or mixtures thereof, are suitable. Phyllosilicates, such as magnesium silicate or aluminum silicate, as well as montmorillonite, saponite, beidellite, nontronite, hectorite, stevensite, vermiculite, halloysite, or synthetic analogs thereof are particularly preferred for use. Of the cristobalite, quartz, and tridynite modifications of silicon dioxide, the quartz modification is preferred.

Magnesium oxide, aluminum oxide, magnesium fluoride, cadmium sulfide, zinc sulfide, cadmium selenide, and the like are additionally suitable as nanoscale filling elements.

In a particularly preferred embodiment of the invention, component (C) is amorphous silicon dioxide.

Small angle neutron scattering (SANS) is utilized as a method for measuring the nanoparticles, in particular the amorphous silicon dioxide particles. This measurement method is familiar to one skilled in the art and requires no further explanation here. A SANS measurement yields a particle size distribution curve in which the volume proportion of particles of a corresponding size (diameter) is plotted against particle diameter. The average particle size is defined for purposes of the invention as the peak of a SANS distribution curve of this kind, i.e. the largest volume fraction having particles of a corresponding diameter. The average particle size is preferably between 6 and 40 nm, in more greatly preferred fashion between 8 and 30 nm, particularly preferably between 10 and 25 nm. The silicon dioxide particles are by preference substantially spherical.

The concentration in the binding agent according to the present invention of the nanoscale filler used as component (C) is 5 wt % to 50 wt %, by preference 20 to 45 wt %, and particularly preferably 30 to 40 wt %.

In a particularly preferred embodiment, the nanoscale filler is dispersed in a flowable phase, the flowable phase containing polymerizable monomers, oligomers, and/or polymers. The flowable phase can be made up of a mixture of components (A), (B), and (D); preferably the flowable phase is constituted by component (A). Particularly preferably, the flowable phase used as a dispersing agent is anhydrous, i.e. contains only small traces of water.

Methods for the manufacture of dispersions of this kind, as well as silicon dioxide dispersions themselves, are disclosed in EP-A1-1236765, the entire content of which is incorporated into the present patent application.

Commercially available dispersions of components (A) and (C) are obtainable from the Hanse Chemie company under the trade name Nanocryl®. Usable products are preferably Nanocryl® XP21/0746, XP21/0768, XP 21/0396, XP 21/1045, or XP 21/1515.

The nanoscale filler described as component (C) is replaced, in the context of the present invention, at least partially by glass-foam powder.

In a further preferred embodiment, the binding agent contains at least one organosilicon compound as component (D).

From the group of organosilicon compounds usable as component (D), at least one three-dimensionally crosslinkable polyorganosiloxane that, after crosslinking, exhibits an average particle diameter in the range from 70 nm to 1000 nm is used as component (D1). Polyorganosiloxanes of this kind are described in EP-B1-0407834 on page 3, line 43 to page 4, line 19.

In a preferred embodiment, component (D) is, as component (D2), a reaction product, preferably an esterification or transesterification product, of acrylic acid and/or methacrylic acid or derivatives thereof with a silane (e) that is characterized by the general formula (II):

Y-A-Si((Z)ₙ)(T)₃₋ₙ (II)

where
Y=an epoxide, —OH, —COOH, —SH, NH₂, NHR″ group;
R″=a linear or branched, saturated or unsaturated C₁-C₁₈ alkyl, C₅-C₈ cycloalkyl, C₆-C₁₀ aryl, C₇-C₁₂ aralkyl radical; an oxyalkylene radical having up to 4 carbon atoms, preferably —(CH₂—CH₂—O)ₘ—H and/or (CH₂—CH(CH₃)—O)ₘ—H; A-Si((Z)ₙ(X)₃₋ₙ; a siloxane radical having approximately 1 to approximately 20 Si atoms and substituted with alkyl, cycloalkyl, or aryl groups;
A=a linear or branched, saturated or unsaturated alkylene group having 1 to 12 carbon atoms, preferably a linear or branched alkylene group having 1 to 4 carbon atoms;
Z=a C₁-C₁₈ alkyl group, preferably a C₁-C₄ alkyl group;
T=—NH₂; —NH—CO—R⁵, —OOC—R⁵; —O—N═C(R⁵)₂ or OR⁵;
R⁵=a linear or branched, saturated or unsaturated C₁-C₁₈ alkyl radical, preferably a methyl, ethyl, propyl, or isopropyl radical;
R⁶=R⁵, preferably a methyl, ethyl, propyl, or isopropyl radical; or an oxyalkylene radical having up to 4 carbon atoms, preferably —(CH₂—CH₂—O)ₘ—H and/or (CH₂—CH(CH₃)—O)ₘ—H; a C₅-C₈ cycloalkyl radical; a C₆-C₁₀ aryl radical, or a C₇-C₁₂ aralkyl radical;
m=1 to 40, preferably 1 to 20, particularly preferably 1 to 10;
n=0, 1, or 2.

Examples of compounds of formula (II) are H₂N—CH₂—Si(O—CH₂—CH₃)₃, HO—CH₂—Si(OCH₃)₃, HO—(CH₂)₃—O—CH₂—Si(O—CH₃)₃, HO—CH₂—CH₂—O—CH₂—Si(OCH₃)₃, (HO—C₂H₄)₂N—CH₂—Si(O—CH₃)₃, HO—(C₂H₄—O)₃—C₂H₄—N(CH₃)—CH₂—Si(O—CH₃)₃, H₂N—CH₂—C₆H₄—CH₂—NH—CH₂—Si(O—CH₃)₃, HS—CH₂—Si(O—OH₃)₃, H₂N—(CH₂)₃—NH—CH₂—Si(OCH₃)₃. H₂N—CH₂—CH₂—NH—CH₂—Si(O—CH₃)₃, HN—((CH₂)₃—Si(O—CH₂—CH₃)₃)₂, or CH₃—(CH₂)₃—NH—(CH₂)₃—Si(O—CH₃)₃, H₂N—(CH₂)₃—Si(O—C₂H₅)₃, H₂N—CH(CH₃)—CH₂—Si(O—CH₃)₃, H₂N—(CH₂)₃—Si(O—CH₃)₃, H₂N—CH₂—CH₂—O—CH₂—CH₂—Si(O—CH₃)₃, (HO—C₂H₄)₂N—(CH₂)₃—Si(O—CH₃)₃, HO—(C₂H₄—O)₃—C₂H₄—N(CH₃)—(CH₂)₃—Si(O—C₄H₉)₃, H₂N—CH₂—C₆H₄—CH₂—CH₂—Si(O—CH₃)₃, H₂N—(CH₂)₃—NH—(CH₂)₃—Si(O—CH₃)₃, H₂N—CH₂—CH₂—NH—(CH₂)₂—Si(OCH₃)₃, H₂N—(CH₂)₂—NH—(CH₂)₃—Si(O—CH₃)₃, H₂N—CH(C₂H₅)—CH₂—Si(O—CH₃)₃, H₂N—CH₂—CH₂—O—CH₂—CH₂—Si(O—C₂H₅)₃, (HO—C₂H₄)₂N—(CH₂)₃—Si(O—C₂H₅)₃, H₂N—CH₂—C₂H₄—CH₂—CH₂—Si(O—C₂H₅)₃, H₂N—(CH₂)₃—NH—(CH₂)₃—Si(O—C₂H₅)₃, H₂N—CH₂—CH₂—NH—(CH₂)₂—Si(O—C₂H₅)₃, H₂N—(CH₂)₂—NH—(CH₂)₃—Si(O—C₂H₅)₃, and mixtures of two or more thereof.

In the context of the present invention, 3-aminopropyltrimethoxysilane, 3-aminopropyldimethoxymethylsilane, 3-aminopropyltriethyoxysilane, 3-aminopropyldimethoxyphenylsilane, and 3-aminopropyldiethoxyethylsilane, in particular 3-aminopropyltrimethoxysilane or bis(3-triethoxysilylpropyl)amine, or mixtures thereof, are preferably used as a silane of the general formula (II).

Commercially obtainable silanes (e) are offered by the Dynamit Nobel company under the designation DYNASYLAN®. These are alkoxysilane derivatives having two or three alkoxy radicals and one or two alkyl radicals, to which functional groups can also additionally be bound, for example amino, mercapto, methacryloxy, or a nitrile group, or a halogen radical such as chlorine.

3-Methacryloxypropyltrimethoxysilane and/or allyltriethoxysilane is used particularly preferably as component (D2).

Component (D2) can be used alone or in a mixture with component (D1).

In a further preferred embodiment, component (D), as component (D3), is a urethane group-containing silane having an isocyanate content <1 wt % NCO, preferably <0.5 wt % NCO, and particularly preferably 0.1 wt % NCO. Component (D3) can be used alone or in a mixture with component (D1) and/or component (D2).

Urethane group-containing silanes of this kind are obtainable by reacting polyisocyanates (c) with silanes (e) of the general formula (II).

Components (D1), (D2), and/or (D3) are preferably contained at a proportion of 0.3 wt % to 20 wt %, preferably 0.4 wt % to 15 wt %, and particularly preferably 0.5 wt %.

From the group of the organosilicon compounds usable as component (D), in a particularly preferred embodiment urethane group-containing silanes having at least one reactive group curable by irradiation are used as component (D4).

Component (D4) is manufactured by reacting at least one polyisocyanate (c) with at least one compound (d) that contains both at least one functional group reactive with NCO groups and at least one reactive functional group curable by irradiation, and with at least one silane (e) of formula (II). Methods of this kind are known to one skilled in the art.

For purposes of the invention, asymmetrical diisocyanates and/or polyurethane prepolymers having free NCO groups are preferably selected from the group of the polyisocyanates (c).

Asymmetrical diisocyanates comprise in the molecule isocyanate groups that differ in terms of their reactivity. Preferred asymmetrical diisocyanates are 2,4-diphenylmethane diisocyanate (MDI), the isomers of toluoylene diisocyanate (TDI), 1-isocyanatomethyl-3-isocyanato-1,5,5-trimethylcyclohexane (IPDI).

Instructions as to the broad spectrum of suitable polyol and isocyanate components, and methods for the manufacture of polyurethane prepolymers, may be inferred by one skilled in the art from the literature regarding polyurethane prepolymers, for example EP 150 444, EP 0 590 398, or WO 99/24486.

It is preferred to use a low-monomer polyurethane prepolymer as polyisocyanate (c), “low-monomer” to be understood in the context of the present invention as a low concentration of the monomeric, in particular aromatic, diisocyanates in the polyurethane prepolymer having free NCO groups. The concentration of these so-called “residual monomers” is below one, by preference between 0 and 0.5 wt %, particularly preferably between 0 and 0.2 wt %, based on the composition of the polyurethane prepolymer having free NCO groups. Low-monomer polyurethane prepolymers having free NCO groups are known, for example, from DE 4136490, WO 01/40342, and WO 97/46603, and are expressly a subject of this invention.

The functional group that is reactive with an NCO group is a group that comprises an active hydrogen atom bound to a nitrogen, oxygen, or sulfur atom and determinable in accordance with the Zerewittinoff test. Included thereamong are, in particular, the hydrogen atoms of water, carboxy, amino, imino, hydroxy, and thiol groups.

It is preferred to use as compound (d), which contains both at least one functional group reactive with NCO groups and at least one reactive functional group curable by irradiation, a (meth)acrylate of the general formula (III):

H₂C═CR¹—C(═O)—O—R²—Y, (III)

where
Y=a group reactive with respect to NCO groups, preferably OH, COOH, SH, NH₂, NHR³;
R¹=H, CH₃;
R²=a saturated or unsaturated, linear or branched alkylene group having 2 to 21 carbon atoms, if applicable substituted with functional groups, for example with a phenoxy or acetoxy group, preferably 2 to 6 carbon atoms, in particular an ethylene, propylene, isopropylene, n-butylene, isobutylene group, or a C₂-C₄ alkylene oxide group, preferably an ethylene oxide and/or propylene oxide group, particularly preferably an ethylene oxide group having 2 to 10 ethylene oxide units and/or a propylene oxide group having 1 to 7 propylene oxide units;
R³=a linear or branched, saturated or unsaturated C₁-C₁₈ alkyl radical; C₅-C₈ cycloalkyl, C₆-C₁₀ aryl, C₇-C₁₂ aralkyl.

The manufacture of such (meth)acrylates of the general formula (III) is known to one skilled in the art.

It is preferred to use hydroxy(meth)acrylates (Y=OH) as (meth)acrylates of the general formula (III), for example: 2-hydroxyethyl acrylate, 2-hydroxyethyl methacrylate, 2-hydroxypropyl acrylate, 2-hydroxypropyl methacrylate, 3-hydroxypropyl acrylate, 3-hydroxypropyl methacrylate, 6-hydroxyhexyl acrylate, 6-hydroxyhexyl methacrylate, polyethylene glycol acrylate, polyethylene glycol methacrylate, polypropylene glycol acrylate and polypropylene glycol methacrylate, glycerol mono(meth)acrylate, 1,3-glycerol di(meth)acrylate, 3-phenoxy-2-hydroxypropyl(meth)acrylate, 3-toluoyloxy-2-hydroxypropyl (meth)acrylate, 3-acetoxy-2-hydroxypropyl(meth)acrylate, 2-hydroxy-3-[(2-methyl-1-oxo-2-propenyl)oxy]propyl esters of 4-hydroxybenzoic acid, 2-hydroxybutyl (meth)acrylate, 3-hydroxybutyl(meth)acrylate, 4-hydroxybutyl(meth)acrylate, 6-hydroxyhexyl(meth)acrylate.

The hydroxyacrylates or -methacrylates are used individually or in a mixture.

The quantities of polyisocyanate (c) and (meth)acrylate of the general formula (III) can be selected within a broad range. For example, the ratio between the NCO group of polyisocyanate (c) and the group Y reactive with respect to NCO groups in the (meth)acrylate of the general formula (III) can be between 0.6:1 and 20:1. Preferably the NCO:Y ratio is 1.2:1 to 10:1.

The molar weight of the reaction product of polyisocyanate (c) with compound (d), which compound contains both at least one functional group reactive with NCO groups and at least one reactive functional group curable by irradiation, is between 100 g/mol and 10,000 g/mol, preferably between 110 g/mol and 6000 g/mol, and particularly preferably between 120 g/mol and 4000 g/mol. The NCO value of the reaction product of polyisocyanate (c) and compound (d), which compound contains both at least one functional group reactive with NCO groups and at least one reactive functional group curable by irradiation, is between 2 wt % and 30 wt %, preferably between 5 wt % and 25 wt % (determined according to Spiegelberger).

Both mixtures of polyisocyanates (c) and/or mixtures of silane (e) can be used to manufacture component (D4).

The reaction of polyisocyanate component (c) with silane (e) takes place at a molar NCO/Y ratio from 1:0.01 to 1, preferably from 1:0.05 to 0.7, and particularly preferably from 1:0.1 to 0.4.

The reaction product of polyisocyanate component (c) and silane (e) has an NCO value from 1 to 30%, preferably 10 to 28%, particularly preferably 15 to 25%, determined according to Spiegelberger, and possesses a molar weight from 100 g/mol to 1000 g/mol. Methods for manufacturing such reaction products, and the reaction products themselves, are disclosed in DE-A1-10162642.

For the manufacture of component (D4), the at least one polyisocyanate (c), the at least one compound (d) that contains both at least one functional group reactive with NCO groups and at least one reactive functional group curable by irradiation, and the at least one silane (e), are caused to react with one another in a so-called “one-pot” reaction. The reaction can also, however, occur in steps, i.e. in a first step (c) is reacted with (d) or (e), and in a second step (e) or (d) is further reacted with the corresponding reaction product from the first step.

At the end of the reaction, component (D4) has a concentration of free monomeric polyisocyanate of <0.05 wt %, based on the total weight of component (D4).

In order to mix component (D) in stable fashion with the binding agent according to the present invention, said component should contain no groups that are reactive with the other constituents under storage conditions. It should, in particular, be free of isocyanate groups.

In a preferred embodiment of the invention, a reaction can occur with component (D) at the surface of component (C), in the presence of a metal compound of formula (IV):

MR⁹ₓ (IV)

as component (E).

The metal M of this compound is selected from those elements of the main groups and subgroups of the periodic system that can exist formally in oxidation state 3 or 4. This preferably means Ge, Sn, Pb, Ti, Zr, B, or Al. Depending on valence, x=3 or 4.

The R⁹ radical, which can be the same or different, is selected from halogen, alkoxy, alkoxycarbonyl, and hydroxyl. Because many metallic compounds having a formal oxidation state of 3 or 4 can also exist as complexes with a plurality of ligands, the binding agent can, however, instead or additionally, also contain compounds in which some or all R⁹ groups of formula (IV) are replaced by one or more ligands L that is/are more strongly bound to the metal M than is the R⁹ group. Compounds of this kind are described, for example, in DE 10044216 A1 (p. 4, lines 1 to 31).

Suitable metal compounds are also known by the designation “adhesion promoters” and represent one or more metal centers such as Si, Ti, Zr, or Al that are bound to functional organic groups.

Corresponding titanium, zirconium, or aluminum compounds are described, for example, in DE 4128743 C2 on pp. 7 and 8, such that r=0 for the Zr and Ti compounds.

Tetrabutyl titanate, tin(II) octanoate, dibutyl tin dilaurate, tetraethoxysilane, or methyltrimethoxysilane is preferably used as component (E). Further metal compounds (IV) usable in preferred fashion as component (E) are described in EP 1342742 A1 on p. 5, lines 28 to 52.

Titanates are obtainable commercially from Kenrich Petrochemicals, Inc. under the designation “KR” or “LICA” substances. Similarly to the aforementioned silanes, these reagents are compounds having alkoxy radicals and additionally, if applicable, radicals that are substituted with functional groups and bound via oxygen to the metal center. The functional groups are, for example, amino, mercapto, or hydroxyl groups.

Suitable zirconate compounds are, for example, the compounds obtainable as “KZ” or “LZ” reagents from Kenrich Petrochemicals, Inc., if applicable having amino or mercapto groups.

Component (E) is used in the binding agent according to the present invention at 0 to 12 wt %, preferably 0.5 to 10 wt %, and particularly preferably from 1 wt % to 5 wt %, based on the total quantity of components used. The reaction takes place, in particular, in response to water, i.e. especially after application as an adhesive, moisture can penetrate into the adhesive and then ensure chemical crosslinking between components C and D, and if applicable E.

The polyreaction of the radiation-curable groups can be initiated by UV, electron beams, visible light, but also IR radiation. With electron or UV irradiation, the desired product properties are set by way of the radiation dose; with IR radiation, via the product temperature and residence time. The progress of photochemical curing can be investigated by IR spectroscopy (intensity and relationship of the C═C and C═O bands).

In the context of the invention, irradiation with UV light or with electron beams is preferred.

For the case in which the radiation-curable binding agent according to the present invention having barrier properties is to be polymerized under UV irradiation, at least one photoinitiator (F) is contained in the binding agent composition.

It is preferred to use a photoinitiator (F) that, upon irradiation with light having a wavelength from approximately 215 to approximately 480 nm, is capable of initiating a radical polymerization of olefinically unsaturated double bonds. Suitable in the content of the present invention for use as photoinitiator (F) are, in principle, all commercially usual photoinitiators that are compatible with the binding agent according to the present invention, i.e., that yield at least largely homogeneous mixtures.

These are, for example, all Norrish type I fragmenting substances. Examples thereof are benzophenone, camphorquinone, QUANTACURE (manufacturer: International Bio-Synthetics), KAYACURE MBP (manufacturer: Nippon Kayaku), ESACURE BO (manufacturer: Fratelli Lamberti), TRIGONAL 14 (manufacturer: Akzo), photoinitiators of the Irgacure® or Darocur® series (Ciba company), for example Darocur® 1173 and/or Fi-4 (manufacturer: Eastman). Especially suitable thereamong are Irgacure® 651, Irgacure® 369, Irgacure® 184, Irgacure® 907, Irgacure® 784, Irgacure® 500, Irgacure® 1000, Darocur® MBF, Irgacure® 1300, Darocur® 4265, Darocur® TPO, Irgacure® 819 and 918 DW, Irgacure® 2022 or Irgacure® 2959 or mixtures of two or more thereof. Additionally suitable are phosphine oxide compounds (LUCIRIN TPO, manufacturer: BASF AG), which can also be used in a mixture with one or more of the aforesaid photoinitiators.

The binding agent according to the present invention having barrier properties contains photoinitiator (F) in a quantity from 0 to 15 wt %, preferably 0.5 to 10 wt %, particularly preferably 1 to 5 wt %, based on the total quantity of binding agent composition.

If applicable, the binding agent according to the present invention can contain additives (G) that can constitute up to approximately 50 wt % of the entire binding agent. Among the additives (G) usable in the context of the present invention are, for example, plasticizers, catalysts, stabilizers, dispersing agents, antioxidants, coloring agents, and further agents for influencing the flowability of the dispersion of component (C) in component (A), (B), or (D) or in a mixture of said components.

The binding agent having barrier properties preferably contains
I) 5 to 80 wt %, preferably up to 60 wt %, in particular up to 45 wt %, particularly preferably 5 to 30 wt % of at least one compound that is flowable in the range from 18° C. to 100° C., preferably 20° C. to 80° C., having at least one reactive functional group curable by irradiation, as component (A);
II) 1 to 70 wt %, preferably over 5 wt %, in particular 10 to 60 wt %, particularly preferably 30 to 40 wt % of at least one compound having at least one reactive functional group curable by irradiation and at least one COOH group, as component (B);
III) 5 to 50 wt %, preferably 20 to 45 wt %, particularly preferably 30 to 40 wt %, of at least one nanoscale filler as component (C), which is preferably selected from the group of: oxides, nitrides, halides, sulfides, carbides, tellurides, selenides of the second to fourth main group, of the transition elements, of the lanthanides, and/or from the group of the polyorganosiloxanes
IV) 0 to 50 wt %, preferably 0.3 to 40 wt %, particularly preferably 0.5 to 30 wt %, of at least one organosilicon compound as component (D);
V) 0 to 12 wt %, preferably 0.5 to 10 wt %, particularly preferably 1 to 5 wt % of a metal compound of formula (IV)

MR⁹ₓ (IV)
where
   M=Ge, Sn, Pb, Ti, Zr, B, Al,
   X=3 or 4,
   R⁹=a halogen, hydroxyl, alkoxy, alkoxycarboxyl group, such that the R radical can be the same or different, as component (E);
VI) 0 to 15 wt %, preferably 0.5 to 10 wt %, particularly preferably 1 to 5 wt % of a photoinitiator, as component (F);
VII) 0 to 50 wt % additives as component (G), selected from the group of plasticizers, catalysts, stabilizers, dispersing agents, antioxidants, coloring agents, and agents for influencing the flowability of the dispersion of component (C) in component (A), (B), or (D) or in a mixture of said components,
the sum of the aforesaid components yielding 100 wt %.

In a particular embodiment, the binding agent having barrier properties contains 10 to 50 wt %, particularly preferably 15 to 40 wt %, of the organosilicon compound as component (D4), component (D4) being obtainable by reacting
(i) a low-monomer polyurethane prepolymer having free NCO groups as polyisocyanate (a), the low-monomer polyurethane prepolymer being an addition product of at least one polyisocyanate of the group IPDI, MDI, or TDI and at least one polyol having a molar weight from 150 g/mol to 2000 g/mol; and at least
(ii) one hydroxyacrylate from the group of 2-hydroxyethyl(meth)acrylate, 2-hydropropyl(meth)acrylate, 3-hydroxypropyl(meth)acrylate, 6-hydroxyhexyl (meth)acrylate; and at least
(iii) one compound of the formula

Y-A-Si((Z)ₙ)(T)₃₋ₙ (II)

where
Y=a group reactive with respect to NCO groups, preferably an —OH, —COOH, —SH, NH₂, NHR″ group;
R″=a linear or branched, saturated or unsaturated C₁-C₁₈ alkyl, C₅-C₈ cycloalkyl, C₆-C₁₀ aryl, C₇-C₁₂ aralkyl radical; an oxyalkylene radical having up to 4 carbon atoms, preferably —(CH₂—CH₂—O)ₘ—H and/or (CH₂—CH(CH₃)—O)ₘ—H; A-Si((Z)ₙ(X)₃₋ₙ; a siloxane radical having approximately 1 to approximately 20 Si atoms and substituted with alkyl, cycloalkyl, or aryl groups;
A=a linear or branched, saturated or unsaturated alkylene group having 1 to 12 carbon atoms, preferably a linear or branched alkylene group having 1 to 4 carbon atoms;
Z=a C₁-C₁₈ alkyl group, preferably a C₁-C₄ alkyl group;
T=—NH₂; —NH—CO—R⁵, —OOC—R⁵; —O—N═C(R⁵)₂ or OR⁶;
R⁵=a linear or branched, saturated or unsaturated C₁-C₁₈ alkyl radical, preferably a methyl, ethyl, propyl, or isopropyl radical;
R⁶═R⁵, preferably a methyl, ethyl, propyl, or isopropyl radical; or an oxyalkylene radical having up to 4 carbon atoms, preferably —(CH₂—CH₂—O)ₘ—H and/or (CH₂—CH(CH₃)—O)ₘ—H; a C₅-C₈ cycloalkyl radical; a C₆-C₁₀ aryl radical, or a C₇-C₁₂ aralkyl radical;
m=1 to 40, preferably 1 to 20, particularly preferably 1 to 10;
n=0, 1, or 2.

The low-monomer polyurethane prepolymer of step (i) contains less than 0.5 wt %, preferably less than 0.3, and particularly preferably less than 0.1 wt % free monomeric polyisocyanate of the group IPDI, MDI, or TDI, based on the total quantity of polyurethane prepolymer. The isocyanate groups that are present should finish reacting during the conversion of constituents i, ii, iii to D4.

In a further preferred embodiment of the invention, components (D1), (D2), and/or (D3) are contained at 0.3 wt % to 20 wt %, preferably 0.4 wt % to 15 wt %, and particularly preferably 0.5 to 10 wt %, based on the total composition of components (I) to (VII).

The radiation-curable binding agent according to the present invention having barrier properties can additionally contain up to 60 wt % of an inert solvent, depending on the required area of application.

All solvents known to one skilled in the art are usable in principle as solvents, in particular esters, ketones, halogenated hydrocarbons, alkanes, alkenes, and aromatic hydrocarbons. Examples of such solvents are methylene chloride, trichloroethylene, toluene, xylene, butyl acetate, amyl acetate, isobutyl acetate, methyl isobutyl ketone, methoxybutyl acetate, cyclohexane, cyclohexanone, dichlorobenzene, diethyl ketone, diisobutyl ketone, dioxane, ethyl acetate, ethylene glycol monobutyl ether acetate, ethylene glycol monoethyl acetate, 2-ethylhexyl acetate, glycol diacetate, heptane, hexane, isobutyl acetate, isooctane, isopropyl acetate, methyl ethyl ketone, tetrahydrofuran, or tetrachloroethylene, or mixtures of two or more of the aforesaid solvents.

The radiation-curable binding agent according to the present invention having barrier properties can be manufactured using usual techniques known to one skilled in the art in the context of the manufacture of polymeric mixtures.

Curing of the binding agent results in blocking-resistant, i.e., non-adhering, and in particular scratch-resistant coatings, fillers, or sealants having flexible properties, or also in surface-tacky adhesives. The radiation-curable binding agents according to the present invention having barrier properties can therefore be used as a coating agent, filler, sealant, or adhesive, and are notable as adhesives, sealants, or fillers having barrier properties with respect to CO₂, O₂, N₂, gas mixtures, e.g., of CO₂ and N₂, water vapor, and aroma chemicals.

The radiation-curable binding agent according to the present invention having barrier properties is usable in principle for the filling, sealing, coating, and adhesive bonding of a wide variety of materials. Included among the materials are, for example, wood, metal, glass, plant fibers, stone, paper, cellulose hydrate, plastics such as polystyrene, polyethylene, polypropylene, polyethylene terephthalate, polyvinyl chloride, copolymers of vinyl chloride and vinylidene chloride, copolymers of vinyl acetate olefins, polyamides, or metal films, for example of aluminum, lead, or copper.

The radiation-curable binding agent according to the present invention having barrier properties can be applied onto the substrate using all suitable methods, for example by spraying, blade-coating, three- to four-roller application units in the case where a solvent-free binding agent is used, or two-roller application units in the case where a solvent-containing binding agent is used.

The radiation-curable binding agent having barrier properties is suitable for coating substrates made of glass, metal, plastic, paper, ceramic, etc., by immersion, casting, brushing, spraying electrostatic spraying, electrocoating, etc. The binding agents are suitable in particular for coating optical, optoelectrical, or electronic articles, and for coating containers for fuels and heating agents.

The radiation-curable binding agent makes available adhesives having barrier properties that are preferably suitable for the manufacture of film composites. A monomeric polyisocyanate content of less than 0.05 wt % makes the binding agent suitable in particular for flexible film composites that are used in the food-packaging sector.

A further subject of the present invention is therefore also a method for manufacturing film composites of at least two similar or different plastic films that are obtainable by partial- or full-coverage adhesive bonding of films using the radiation-curable binding agent according to the present invention having barrier properties.

Application of the binding agent onto the films to be adhesively bonded can be accomplished with machines usually used for such purposes, for example with conventional laminating machines. It is particularly suitable to apply the binding agent in the liquid state onto a film that is to be adhesively bonded into a laminate, for example a plastic or metal film. The viscosity of the binding agent is selected so that it has, at typical processing temperatures, a viscosity from approximately 1000 mPa·s to approximately 5000 mPa·s (measured with a Brookfield RVT DV-II digital viscosimeter, spindle 27). Typical processing temperatures are, for example, approximately 25° C. to approximately 75° C. for the manufacture of flexible packaging films, approximately 70 to approximately 90° C. for the lamination of high-gloss films, and approximately 80 to approximately 130° C. for applications in the textile sector.

The film coated with the solvent-containing radiation-curable binding agent having barrier properties is first dried in the drying tunnel at 40 to 120° C., then laminated with at least one further film, if applicable under pressure, and then irradiated. For the solvent-free binding agents, the drying step is omitted.

The radiation-curable binding agent having barrier properties gains molecular weight as a result of the irradiation and the crosslinking reaction associated therewith, and thereby has more cohesion and possesses a contact-adhesive surface. If the irradiation is performed using UV light, the binding agent used according to the present invention contains at least one photoinitiator as component (F).

The method described can be repeated several times, so that film composites made up of more than two adhesively bonded layers can be manufactured.

The method according to the present invention can be carried out in a shielding gas atmosphere, i.e., in the presence of inert gases such as nitrogen. It can also, however, advantageously be carried out without difficulty in a normal atmosphere such as the one typically present in production facilities.

A further subject of the invention is a composite film manufactured using the binding agent. The composite film is suitable, in particular, as a barrier film for packaging foods. The term “barrier film” is used in food packaging practice when the oxygen permeability Q(O₂) is less than 100 cm³/(m²×day×bar), and the water vapor permeability Q(H₂O) is less than 10 g/(m²×day) at 23° C. and 85% relative humidity (Delventhal, Verpackungs-Rundschau 3/1991, pp. 19-23).

The polymer contained as a binding agent in the adhesive, sealant, or coating material according to the present invention advantageously corresponds, according to a further embodiment, to the general formula (I)

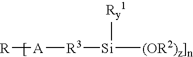

in which R is an organic basic framework, A denotes a carboxy, carbamate, carbonate, ureido, urethane, or sulfonate bond or an oxygen atom, R¹ is an alkyl radical having 1 to 4 carbon atoms or OR², R² is an alkyl radical having 1 to 4 carbon atoms or an acyl radical having 1 to 4 carbon atoms, R³ is a straight-chain or branched, substituted or unsubstituted alkylene radical having 1 to 8 carbon atoms, y=0 to 2, z=3−y, and n=1 to 10,000, such that the silyl radical can be the same or different, and in the case of multiple R¹ and R² radicals, they can be respectively the same or different.

The organic basic framework is advantageously selected from the group encompassing alkyd resins, oil-modified alkyd resins, unsaturated polyesters, natural oils, e.g., linseed oil, tung oil, soybean oil, and epoxides, polyamides, thermoplastic polyesters such as, for example, polyethylene terephthalate and polybutylene terephthalate, polycarbonates, polyethylenes, polybutylenes, polystyrenes, polypropylenes, ethylene/propylene co- and terpolymers, acrylates, e.g., homo- and copolymers of acrylic acid, of acrylates, of methacrylates, of acrylamides, and of their salts and the like, phenolic resins, polyoxymethylene homo- and copolymers, polyurethanes, polysulfones, polysulfide rubbers, nitrocellulose, vinyl butyrates, vinyl polymers, e.g., polymers containing vinyl chloride and/or vinyl acetate; ethyl cellulose, cellulose acetates and butyrates, rayon, shellac, waxes, ethylene copolymers such as, for example, ethylene-vinyl acetate copolymers, ethylene-acrylic acid copolymers, ethylene-acrylate copolymers, organic rubbers, silicone resins, and the like. Further examples include polyethers such as polyethylene oxide, polypropylene oxide, and polytetrahydrofuran, polyol, poly(meth)acrylate, and polyvinyl alcohol. Of the aforesaid polymeric basic frameworks, polyethers, polyesters, polyurethanes, and polyols are particularly preferred.

Further advantageous compositions represent physically setting adhesives, sealants, and coating materials. “Physically setting” adhesives, sealants, and coating materials are understood as, for example, dispersion adhesives, solvent adhesives, and hot melt adhesives.

Dispersion adhesives are usually manufactured by combining polymer dispersions such as, for example, polyvinyl acetate and polyacrylate dispersions.

A preferred composition encompasses an aqueous dispersion made up of copolymers of styrene or alpha-methyl styrene with dienes or with acrylic derivatives from the group of styrene-butadiene, styrene-acrylonitrile, styrene-alkyl methacrylate, styrene-butadiene-alkyl acrylate and methacrylate, styrene-maleic acid anhydride, styrene-acrylonitrile-methyl acrylate; mixtures of high impact toughness made up of styrene copolymers and another polymer such as, for example, a polyacrylate, a diene polymer, or an ethylene-propylene-diene terpolymer; as well as block copolymers of styrene such as, for example styrene-butadiene-styrene (SBS), styrene-isoprene-styrene, styrene-ethylene/butylene-styrene, or styrene-ethylene/propylene-styrene.

A preferred composition further encompasses at least one aqueous emulsion of natural or synthetic rubbers, such as, e.g., natural rubber latex or latexes of carboxylated styrene-butadiene copolymers. This preferred composition can be used, according to the present invention, alone as a so-called 100% system, or dispersed in water, or dissolved in a solvent.

A further preferred composition encompasses polymers that derive from alpha, beta-unsaturated acids and derivatives thereof, such as polyacrylates and polymethacrylates, polyacrylamides, and polyacrylonitriles. This preferred composition can be used, according to the present invention, alone as a so-called 100% system, or dispersed in water, or dissolved in a solvent.

A further preferred composition encompasses halogen-containing polymers such as, for example, polychloroprene, chlorine rubber, chlorinated or chlorosulfonated polyethylene, copolymers of ethylene and chlorinated ethylene, epichlorohydrin homo- and copolymers, in particular polymers of halogen-containing vinyl compounds such as, for example, polyvinyl chloride, polyvinylidene chloride, polyvinyl fluoride, polyvinylidene fluoride; as well as copolymers thereof, such as vinyl chloride-vinylidene chloride, vinyl chloride-vinyl acetate, or vinylidene chloride-vinyl acetate. This preferred composition can be used, according to the present invention, alone as a so-called 100% system, or dispersed in water, or dissolved in a solvent.

The composition according to the present invention can furthermore contain fillers such as, for example, chalk, talcum, barite, gypsum, or titanium dioxide, and furthermore plasticizers such as, for example, phthalic acid esters, adipates, benzoates, citrates, or alkylbenzenes, and furthermore resins such as, for example, colophon, colophon esters, hydrocarbon resins, or abietol, and furthermore solvents such as, for example, acetone, acetic ester, toluene, benzol, cyclohexane, or THF.

What is claimed is:

1. A chemically or physically curable composition suitable for use as an adhesive, sealant or coating material, said composition containing at least one binding agent selected from the group consisting of crosslinkable monomers, polymerizable monomers, prepolymers, and polymers, as well as at least one filler, wherein the filler proportion is 0.2 to 70 wt % based on the total weight of the composition, and at least a portion of the filler is made up of glass particles having a particle size from 100 nm to 20 μm, wherein said glass particles:
a) have been obtained by comminuting foamed neutral or acid glass;
b) are made up of flat glass platelets that were manufactured from a glass melt under vacuum, the glass melt having been driven outward in a rotating crucible and having dissociated into the platelets upon cooling;
c) are amorphous synthetic quartz glass (fused silica) or flake-shaped glass particles obtained by pulling a glass capillary and comminuting the cooled glass capillary; or
d) have been obtained by processing molten glass into thin layers, hollow spheres, or tubules, and comminuting the layers, hollow spheres, or tubules after cooling.

2. A composition according to claim 1, wherein the surface of the glass particles is chemically modified.

3. A composition according to claim 1 containing 2-cyanoacrylic acid esters as crosslinkable monomers.

4. A composition according to claim 1 containing as a binding agent a polyurethane binding agent based on at least one polyisocyanate and at least one polyol and/or polyamine.

5. A composition according to claim 1 containing as a binding agent a dispersion based on polyvinyl acetate, polyacrylate, styrene/butadiene copolymer, polyvinylidene, polyurethane, polychloroprene, rubber, vinyl acetate/acrylate copolymer, maleinate, or polyolefin.

6. A composition according to claim 1 containing as a binding agent a hot melt adhesive.

7. A composition according to claim 6, wherein the hot melt adhesive is selected from the group consisting of pressure-sensitive adhesives, polyolefins, ethylene/vinyl acetate copolymers, polyamides, polyurethanes, silane-terminated polyurethanes, and silane-terminated polyamides.

8. A composition according to claim 1 containing as a binding agent one or more epoxy resins.

9. A composition according to claim 1 containing one or more binding agents selected from the group consisting of silicones, silane-curing polymers, modified silicones (MS polymers), polysulfides, polyurethanes, rubber, polyacrylates, dispersion sealants, polyvinyl chloride, and plastisols.

10. A composition according to claim 1 containing as a binding agent a two-component polyurethane binding agent and a further filler in addition to the glass particles selected from the group consisting of wood particles and cellulose-containing materials.

11. A composition according to claim 1 wherein from 50 to 100% of said filler is made up of said glass particles having a particle size from 100 nm to 20 μm.

12. A composition according to claim 1, wherein said glass particles have been obtained by comminuting foamed neutral or acid glass.

13. A composition according to claim 1, wherein said glass particles are made up of flat glass platelets that were manufactured from a glass melt under vacuum, the glass melt having been driven outward in a rotating crucible and having dissociated into the platelets upon cooling.

14. A composition according to claim 1, wherein said glass particles are amorphous synthetic quartz glass (fused silica) or flake-shaped glass particles obtained by pulling a glass capillary and comminuting the cooled glass capillary.

15. A composition according to claim 1, wherein said glass particles have been obtained by processing molten glass into thin layers, hollow spheres, or tubules, and comminuting the layers, hollow spheres, or tubules after cooling.
